(19) United States
(12) Patent Application Publication
(10) Pub. No.: US 2009/0063556 A1
(43) Pub. Date: Mar. 5, 2009

(54) ROOT NODE FOR CARRYING OUT FILE LEVEL VIRTUALIZATION AND MIGRATION

(76) Inventors: Jun Nemoto, Kawasaki (JP); Takaki Nakamura, Ebina (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/020,770

(22) Filed: Jan. 28, 2008

(30) Foreign Application Priority Data
Aug. 31, 2007 (JP) 2007-226466

(51) Int. Cl. G06F 17/30

(52) U.S. Cl. 707/103 R; 707/E17.055

(57) ABSTRACT

An object ID comprises share information denoting a share unit, which is a logical export unit, and which includes one or more objects. Migration determination information denoting whether or not migration has been completed for each share unit is provided. A root node maintains the object ID in the migration destination of a migrated file, and updates migration determination information to information denoting that the share unit comprising this file is a migrated share unit. The root node, upon receiving request data having the object ID, determines, by referencing the above-mentioned migration determination information, whether or not the share unit denoted by the share information inside this object ID is a migrated share unit, and if this unit is a migrated share unit and if the file identified from this object ID is a migrated file, transfers the request data having the migration-destination object ID corresponding to this file to the migration-destination node.

### CROSS-REFERENCE TO PRIOR APPLICATION

This application relates to and claims the benefit of priority from Japanese Patent Application number 2007-226466, filed on Aug. 31, 2007 the entire disclosure of which is incorporated herein by reference.

### BACKGROUND

The present invention generally relates to technology for data migration between file servers.

A file server is an information processing apparatus, which generally provides file services to a client via a communications network. A file server must be operationally managed so that a user can make smooth use of the file services. HSM (Hierarchy Storage Management) is an important technique for operationally managing a file server. In HSM, high-access-frequency data is stored in expensive, highspeed, low-capacity storage, and low-access-frequency data is stored in inexpensive, low-speed, high-capacity storage. Data migration is an important HSM-related factor in the operational management of a file server. Since the frequency of data utilization changes over time, efficient HSM can be realized by appropriately redistributing high-access-frequency data and low-access-frequency data in file units or directory units.

One method for carrying out data migration between file servers in file units or directory units makes use of an apparatus (hereinafter, root node) for relaying communications between a client and a file server (For example, see US Unexamined Patent Specification No. 2004/0267830 and Japanese Patent Laid-open No. 2003-203029). The root nodes disclosed in US Unexamined Patent Specification No. 2004/0267830 and Japanese Patent Laid-open No. 2003-203029 will be referred to as “conventional root node” hereinbelow.

A conventional root node has functions for consolidating the exported directories of a plurality of file servers and constructing a pseudo file system, and can receive file access requests from a plurality of clients. Upon receiving a file access request from a certain client for a certain object (file), the conventional root node executes processing for transferring this file access request to the file server in which this object resides by converting this file access request to a format that this file server can comprehend.

Further, when carrying out data migration between file servers, the conventional root node keeps the data migration concealed from the client, enables post-migration file access via the same namespace as prior to migration.

When a client makes a request to a file server for file access to a desired object, generally speaking, an identifier called an object ID is used to identify this object. For example, in the case of the file sharing protocol NFS (Network File System), an object ID called a file handle is used.

Because an object ID is created in accordance with file server-defined rules, the object ID itself will change when data is migrated between file servers (that is, the object ID assigned to the same object by a migration-source file server and a migration-destination file server will differ.). Thus, the client is not able to access this object if it request file access to the desired object using the pre-migration object ID (hereinafter, migration-source object ID).

Therefore, it is necessary manage the pre-migration and post-migration object IDs, and to conceal the data migration from the client so that trouble does not occur in the client due to the change of the object ID.

The root node disclosed in US Unexamined Patent Specification No. 2004/0267830 maintains a table, which registers the corresponding relationship between the migration-source object ID in the migration-source file server and the post-migration object ID (hereinafter, the migration-destination object ID) in the migration-destination file server. Then, upon receiving a file access request with a migration-source object ID from a client, the root node disclosed in US Unexamined Patent Specification No. 2004/0267830 transfers the file access request to the appropriate file server after rewriting the migration-source object ID to a migration-destination object ID by referring to the above-mentioned table.

When a plurality of US Unexamined Patent Specification No. 2004/0267830 root nodes is used to carry out load balancing, the corresponding relationship between the migration-source object ID and the migration-destination object ID must be synchronized among the root nodes. For this reason, the problem is that, when huge numbers of objects are migrated, the synchronization processing load increases, thereby lowering transfer processing performance for requests from the client.

The root node of Japanese Patent Laid-open No. 2003-203029 saves the migration-source file as a stub file, and when there is a request for the stub file from a client, the root node uses the migration-destination information inside the stub file to transfer the request to the migration-destination file server.

The problem with the root node of Japanese Patent Laid-open No. 2003-203029, is that, as a rule, this root node must check whether or not there is a stub file for all requests, even if the request is for an object that is not related to the migration, thereby lowering the performance of ordinary request transfer processing.

### SUMMARY

Therefore, an object of the present invention is to provide a file level data migration technique, which moderates the drop in performance for request transfer processing.

Other objects of the present invention should become clear from the following explanation.

An object ID for identifying a file, which is one object, comprises share information denoting a share unit, which is a logical export unit, and which includes one or more objects. Further, migration determination information denoting whether or not migration has ended for each share unit is provided. The root node maintains the object ID in the migration destination of a migrated file when a file is migrated another node, and updates the migration determination information to information denoting that the share unit comprising this file is a migrated share unit. The root node, upon receiving request data having an object ID, determines whether or not a share unit denoted by the share information inside this object ID is a migrated share unit by referring to the above-mentioned migration determination information, and if the file identified from this object ID is a migrated file when the share unit is a migrated share unit, transfers the request data having a migration-destination object ID corresponding to this file to the migration-destination node.

### BRIEF DESCRIPTION OF THE DRAWINGS

FIG. 1 is a diagram showing an example of the constitution of a computer system comprising a root node related to the first embodiment of the present invention;

FIG. 2 is a block diagram showing an example of the constitution of a root node related to the first embodiment of the present invention;

FIG. 3 is a block diagram showing an example of the constitution of a leaf node related to the first embodiment of the present invention;

FIG. 4 is a block diagram showing a parent configuration information management program;

FIG. 5 is a block diagram showing an example of the constitution of a child configuration information management program;

FIG. 6 is a block diagram showing an example of the constitution of a switching program;

FIG. 7 is a block diagram showing an example of the constitution of a file system program;

FIG. 8 is a block diagram showing an example of the constitution of file access management module;

FIG. 9 is a diagram showing an example of the constitution of a switching information management table;

FIG. 10 is a diagram showing an example of the constitution of a server information management table;

FIG. 11 is a diagram showing an example of the constitution of an algorithm information management table;

FIG. 12 is a diagram showing an example of the constitution of a connection point management table;

FIG. 13 is a diagram showing an example of the constitution of a GNS configuration information table;

FIG. 14A is a diagram showing an example of an object ID exchanged in the case of an extended format OK;

FIG. 14B(a) is a diagram showing an example of an object ID exchanged between a client and a root node, and between a root node and a root node in the case of an extended format NG;

FIG. 14B(b) is a diagram showing an example of an object ID exchanged between a root node and a leaf node in the case of an extended format NG;

FIG. 15A shows an example of a file for which data migration processing is not being carried out;

FIG. 15B shows an example of a file for which data migration processing has been carried out;

FIG. 15C shows an example of a data migration-destination file;

FIG. 16 is a flowchart of processing in which a root node provides a GNS;

FIG. 17 is a flowchart of processing (response processing) when a root node receives response data;

FIG. 18 is a flowchart of GNS local processing executed by a root node;

FIG. 19 is a flowchart of connection point processing executed by a root node;

FIG. 20 is a flowchart of data migration processing by a first embodiment;

FIG. 21 is a flowchart of file copy processing carried out during a data migration process by the first embodiment;

FIG. 22 is a flowchart of processing carried out by the root node, which has received request data from the client;

FIG. 23 is a diagram showing an example of the constitution of a computer system comprising a root node related to a second embodiment of the present invention;

FIG. 24 is a block diagram showing an example of the constitution of the root node in the second embodiment;

FIG. 25 is a block diagram showing an example of the constitution of a leaf node in the second embodiment;

FIG. 26 is a block diagram showing an example of the constitution of a parent data transfer program;

FIG. 27 is a block diagram showing an example of the constitution of a child data transfer program;

FIG. 28 is a flowchart of file copy processing carried out during a data migration process in the second embodiment;

FIG. 29 is a flowchart of parent data transfer processing;

FIG. 30 is a flowchart of child data transfer processing;

FIG. 31A shows an example of the constitution of a file level migration share list; and

FIG. 31B shows the flow of processing carried out for returning data in a migration-destination file to a migration-source file.

### DESCRIPTION OF THE PREFERRED EMBODIMENTS

In Embodiment 1, the root node is an apparatus for carrying out file level virtualization for providing a plurality of share units that are logical export units and that include one or more objects, to a client as a single virtual namespace, and is logically arranged between a client and a file server. This root node comprises a migration processing module (for example, migration processing means), and a request transfer processing module (for example, request transfer processing means). The migration processing module migrates a file (for example, a file included in a migration target specified by a user, or an arbitrarily selected file), which is an object, either to a leaf node, which is a file server for managing a share unit, or to an other root node, writes a migration-destination object ID as an object ID comprising share information denoting a share unit, and updates migration determination information denoting a share unit, which either comprises or does not comprise a migrated file, to information denoting that a migrated file is included in the share unit comprising the above-mentioned file. The request transfer processing module receives request data having an object ID from either a client or an other root node, and determines, by referring to the above-mentioned migration determination information, whether or not the share unit denoted by the share information inside the object ID of this request data is a migrated share unit comprising a migrated file. If the result of this determination is positive, the request transfer processing module specifies the above-mentioned migration-destination object ID corresponding to this object ID, and transfers the request data having the specified migration-destination object ID to either the migration-destination leaf node or the other root node.

In Embodiment 2 according to the Embodiment 1, when the result of the above-mentioned determination is negative, the request transfer processing module executes an operation in accordance with the request data without transferring this request data. For example, when the request data is a read request, the operation is a process for reading out the file identified from the object ID of this request data, and sending this file to the source of the request data, and when the request data is a write request, the operation is a process for updating the file identified from the object ID of this request data.

In Embodiment 3 according to either the Embodiments 1 or 2, the request transfer processing module references transfer control information in which share information corresponds to node information denoting either the leaf node or root node that manages the share unit denoted by this share information, and specifies the node information corresponding to the share information inside the object ID of the above-mentioned received request data. If the specified node information denotes the above-mentioned root node, the request transfer processing module carries out the above-mentioned determination, and if the specified node information denotes either a leaf node or another root node, the request transfer processing module transfers the above-mentioned received request data to either this leaf node or this other root node.

In Embodiment 4 according to any of the Embodiments 1 to 3, the write destination of the migration-destination object ID is the migration-source file.

In Embodiment 5 according to the Embodiment 4, a file comprises attribute information related to the file, and real data, which is the data constituting the content of the file. The write destination of the migration-destination object ID is the attribute information inside the migration-source file.

In Embodiment 6 according to any of the Embodiments 1 to 5, a file comprises attribute information related to the file, and real data, which is the data constituting the content of the file. The migration processing module migrates the real data inside this file to either the leaf node or another root node without migrating the attribute information in the file.

In Embodiment 7 according to the Embodiment 6, the migration processing module deletes the migrated real data from the migration-source file.

In Embodiment 8 according to either Embodiments 6 or 7, when the result of the above-mentioned determination is positive and if the above-mentioned received request data is data by which a response is possible without either referencing or updating the attribute information inside the migration-source file identified from the object ID of this request data, and without referencing or updating the real data, the request transfer processing module either references or updates the attribute information inside this migration-source file, and sends the response data corresponding to this request data to the source of this request data without sending this request data to either the migration-destination leaf node or other root node.

In Embodiment 9 according to the Embodiment 8, if the above-mentioned received request data is data for which the real data inside the migration-source file has to be either referenced or updated, and the attribute information inside this migration-source file has to be updated when this request data is processed, the request transfer processing module changes the attribute information inside this migration-source file, and subsequently sends response data relative to this request data either to the above-mentioned client or to another root node which is the source of this request data.

In Embodiment 10 according to any of the Embodiments 1 to 9, the migration processing module acquires the file migrated from the share unit managed by the above-mentioned root node from either the migration-destination leaf node thereof, or another root node, and if all the files migrated from this share unit have been acquired, updates the above-mentioned migration determination information to information denoting that this share unit does not comprise a migrated file.

In Embodiment 11 according to the Embodiment 10, a file comprises attribute information related to the file, and real data, which is the data constituting the content of the file, and the migration processing module migrates the real data in this file either to the leaf node or to the other root node without migrating the attribute information in the file, acquires the real data migrated from the share unit managed by this root node from either the migration-destination leaf node thereof or the other root node, and returns this real data to the migration-source file, and if all the real data migrated from this share unit has been acquired and respectively returned to all the migration-source files, the migration processing module updates the above-mentioned migration determination information to information denoting that this share unit does not comprise a migrated file.

In Embodiment 12 according to any of the Embodiments 1 to 11, a client, root node, and leaf node or other root node are connected to a first communication network (for example, a LAN (Local Area Network)). A storage unit, which stores an object included in a share unit, the above-mentioned root node, and leaf node or other root node are connected to a second network (for example, a SAN (Storage Area Network)), which is a different communication network from the first communication network.

In Embodiment 13 according to the Embodiment 12, the migration processing module sends layout information denoting information related to the layout of a migration-source file either to the migration-destination leaf node or other root node by way of the first communication network, receives an object ID of a migration-destination file created based on this layout information from either the migration-destination leaf node or other root node by way of the first communication network, and writes the above-mentioned received object ID as the migration-destination object ID.

At least one of all of the modules (migration processing module, request transfer processing module) can be constructed from hardware, computer programs, or a combination thereof (for example, some can be implemented via computer programs, and the remainder can be implemented using hardware). A computer program is read in and executed by a prescribed processor. Further, when a computer program is read into a processor and information processing is executed, a storage region that resides in memory or some other such hardware resource can also be used. Further, a computer program can be installed in a computer from a CD-ROM or other such recording medium, or it can be downloaded to a computer via a communications network.

A number of the embodiments of the present invention will be explained in detail below. First, an overview of these embodiments will be explained.

A migration-targeted object is a file. A migration is carried out by leaving the directory structure as-is in the migration-source file server. The file comprises attribute information (for example, information comprising basic attribute information and extended attribute information, which will be explained hereinbelow), and real data. The attribute information inside the file is left as-is, and only the real data inside the file is copied to the migration-destination node (either a leaf node or another root node), after which, this real data is deleted from the migration-source file. Furthermore, migration-source file attribute information (for example, extended attribute information) comprises the object ID of the migration-destination file (migration-destination object ID).

Upon receiving request data comprising a migration-source object ID from a client (or other root node), the file-migrating root node first determines if this request data is for an object inside a remote share unit, or for an object inside a local share unit (hereinafter, remote/local determination). When it is determined from the result of the remote/local determination that the request data is for an object inside a remote share unit, the root node carries out a first transfer process (a share-level transfer process) for transferring this request data to either the remote root node or leaf node thereof. Conversely, when it is determined from the result of the remote/local determination that the request data is for an object inside a local share unit, the root node determines (hereinafter, migration determination) whether or not there is a file from which real data has been migrated inside this local share unit (migrated file). When the result of this migration determination is that a migrated file is included inside the relevant share unit, if the above-mentioned received request data is either a read request or a write request, and if the file identified from the migration-source object ID is a migration-source file, the root node acquires the migration-destination object ID comprised in the attribute information inside the migration-source file, and carries out a second transfer process (a file-level transfer process) for transferring the request data comprising this migration-destination object ID to either the leaf node or the other root node of the migration destination.

That is, a migration-source root node carries out a virtualization process for enabling a client to access a migration-destination file with a migration-source object ID. Further, the file system of the migration-source root node maintains the corresponding relationship between the object ID of the migration-source file and the object ID of the migration-destination file required for that purpose by including this relationship in the attribute information inside the migration-source file. Thus, it is not necessary to synchronize the corresponding relationship of the migration-source file object ID and the migration-destination file object ID between the migration-source and migration-destination nodes. In addition, the determination as to whether or not the request data from the client (or other root node) is a file relative to a migrated file is carried out in share units. These factors make it possible to realize high scalability and to moderate reductions in request transfer processing performance.

### First Embodiment

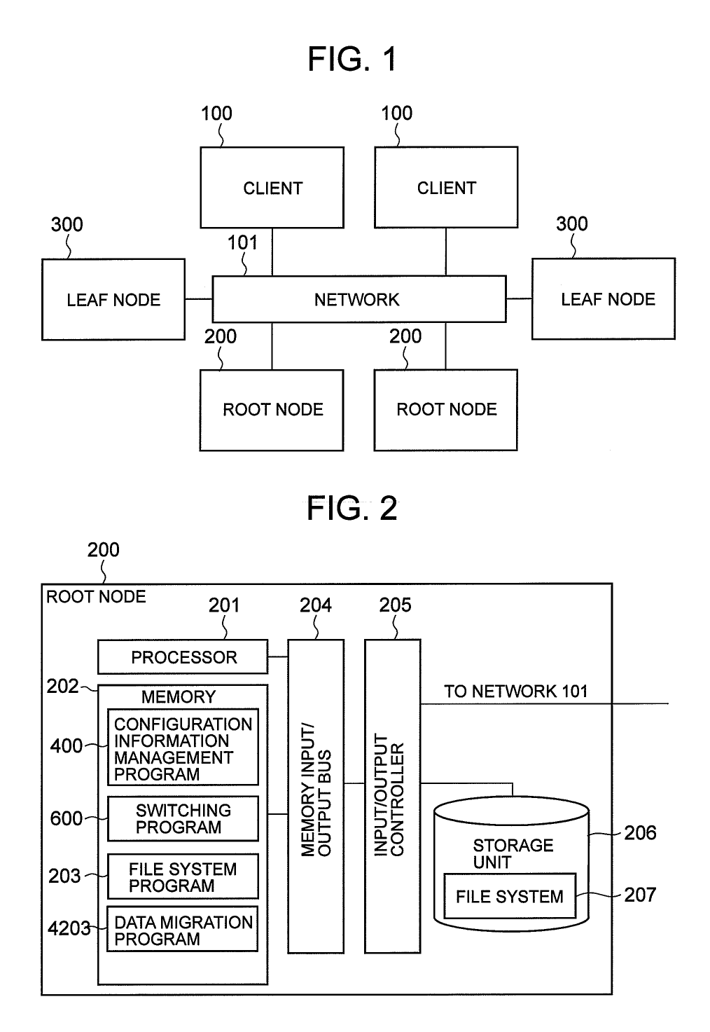

FIG. 1 is a diagram showing an example of the constitution of a computer system comprising a root node related to the first embodiment of the present invention.

At least one client 100, at least one root node 200, and at least one leaf node 300 are connected to a communications network (for example, a LAN (Local Area Network)) 101. The leaf node 300 can be omitted altogether.

The leaf node 300 is a file server, which provides the client 100 with file services, such as file creation and deletion, file reading and writing, and file movement.

The client 100 is a device, which utilizes the file services provided by either the leaf node 300 or the root node 200.

The root node 200 is located midway between the client 100 and the leaf node 300, and relays a request from the client 100 to the leaf node 300, and relays a response from the leaf node 300 to the client 100. A request from the client 100 to either the root node 200 or the leaf node 300 is a message signal for requesting some sort of processing (for example, the acquisition of a file or directory object, or the like), and a response from the root node 200 or the leaf node 300 to the client 100 is a message signal for responding to a request. Furthermore, the root node 200 can be logically positioned between the client 100 and the leaf node 300 so as to relay communications therebetween. The client 100, root node 200 and leaf node 300 are connected to the same communications network 101, but logically, the root node 200 is arranged between the client 100 and the leaf node 300, and relays communications between the client 100 and the leaf node 300.

The root node 200 not only possesses request and response relay functions, but is also equipped with file server functions for providing file service to the client 100. The root node 200 constructs a virtual namespace when providing file services, and provides this virtual namespace to the client 100. A virtual namespace consolidates all or a portion of the sharable file systems of a plurality of root nodes 200 and leaf nodes 300, and is considered a single pseudo file system. More specifically, for example, when one part (X) of a file system (directory tree) managed by a certain root node 200 or leaf node 300 is sharable with a part (Y) of a file system (directory tree) managed by another root node 200 or leaf node 300, the root node 200 can construct a single pseudo file system (directory tree) comprising X and Y, and can provide this pseudo file system to the client 100. In this case, the single pseudo file system (directory tree) comprising X and Y is a virtualized namespace. A virtualized namespace is generally called a GNS (global namespace). Thus, in the following explanation, a virtualized namespace may be called a “GNS”.

Conversely, a file system respectively managed by the root node 200 and the leaf node 300 may be called a “local file system”. In particular, for example, for the root node 200, a local file system managed by this root node 200 may be called “own local file system”, and a local file system managed by another root node 200 or a leaf node 300 may be called “other local file system”.

Further, in the following explanation, a sharable part (X and Y in the above example), which is either all or a part of a local file system, that is, the logical public unit of a local file system, may be called a “share unit”. In this embodiment, a share ID, which is an identifier for identifying a share unit, is allocated to each share unit, and the root node 200 can use a share ID to transfer a file access request from the client 100. A share unit comprises one or more objects (for example, a directory or file).

Further, in this example 1 of one embodiment, one of a plurality of root nodes 200 can control the other root nodes 200. Hereinafter, this one root node 200 is called the “parent root node 200p”, and a root node 200 controlled by the parent root node is called a “child root node 200c”. This parent-child relationship is determined by a variety of methods. For example, the root node 200 that is initially booted up can be determined to be the parent root node 200p, and a root node 200 that is booted up thereafter can be determined to be a child root node 200c. A parent root node 200p, for example, can also be called a master root node or a server root node, and a child root node 200c, for example, can also be called a slave root node or a client root node.

FIG. 2 is a block diagram showing an example of the constitution of a root node 200.

A root node 200 comprises at least one processor (for example, a CPU) 201; a memory 202; a memory input/output bus 204, which is a bus for input/output to/from the memory 202; an input/output controller 205, which controls input/output to/from the memory 202, a storage unit 206, and the communications network 101; and a storage unit 206. The memory 202, for example, stores a configuration information management program 400, a switching program 600, a data migration program 4203 and a file system program 203 as computer programs to be executed by the processor 201. The storage unit 206 can be a logical storage unit (a logical volume), which is formed based on the storage space of one or more physical storage units (for example, a hard disk or flash memory), or a physical storage unit. The storage unit 206 comprises at least one file system 207, which manages files and other such data. A file can be stored in the file system 207, or a file can be read out from the file system 207 by the processor 201 executing the file system program 203. Hereinafter, when a computer program is the subject, it actually means that processing is being executed by the processor, which executes this computer program.

The data migration program 4203 carries out data migration from the root node 200 to another root node 200, and carries out the migration of data from the root node 200 to the leaf node 300. The operation of the data migration program 4203 will be explained in detail hereinbelow.

The configuration information management program 400 is constituted so as to enable the root node 200 to behave either like a parent root node 200p or a child root node 200c. Hereinafter, the configuration information management program 400 will be notated as the “parent configuration information management program 400p” when the root node 200 behaves like a parent root node 200p, and will be notated as the “child configuration information management program 400c” when the root node 200 behaves like a child root node 200c. The configuration information management program 400 can also be constituted such that the root node 200 only behaves like either a parent root node 200p or a child root node 200c. The configuration information management program 400, file system program 203 and switching program 600 will be explained in detail hereinbelow.

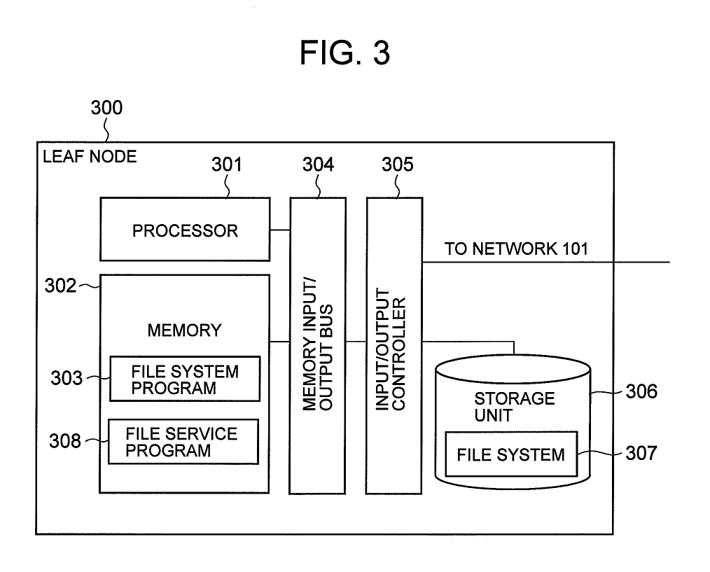

FIG. 3 is a block diagram showing an example of the constitution of a leaf node 300.

A leaf node 300 comprises at least one processor 301; a memory 302; a memory input/output bus 304; an input/output controller 305; and a storage unit 306. The memory 302 comprises a file service program 308 and a file system program 303. Although not described in this figure, the memory 302 can further comprise a configuration information management program 400. The storage unit 306 stores a file system 307.

Since these components are basically the same as the components of the same names in the root node 200, explanations thereof will be omitted. Furthermore, the storage unit 306 can also exist outside of the leaf node 300. That is, the leaf node 300, which has a processor 301, can be separate from the storage unit 306.

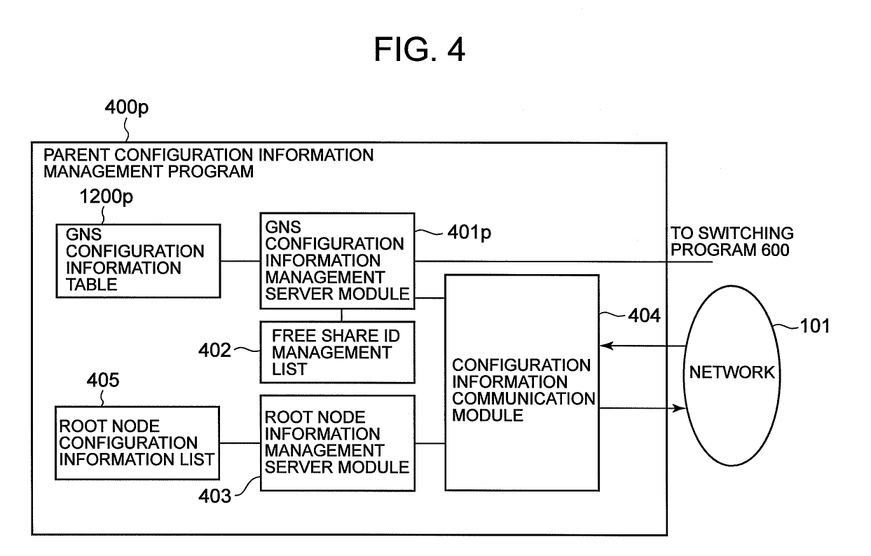

FIG. 4 is a block diagram showing an example of the constitution of a parent configuration information management program 400p.

A parent configuration information management program 400p comprises a GNS configuration information management server module 401p; a root node information management server module 403; and a configuration information communications module 404, and has functions for referencing a free share ID management list 402, a root node configuration information list 405, and a GNS configuration information table 1200p. Lists 402 and 405, and GNS configuration information table 1200p can also be stored in the memory 202.

The GNS configuration information table 1200p is a table for recording GNS configuration definitions, which are provided to a client 100. The details of the GNS configuration information table 1200p will be explained hereinbelow.

The free share ID management list 402 is an electronic list for managing a share ID that can currently be allocated. For example, a share ID that is currently not being used can be registered in the free share ID management list 402, and, by contrast, a share ID that is currently in use can also be recorded in the free share ID management list 402.

The root node configuration information list 405 is an electronic list for registering information (for example, an ID for identifying a root node 200) related to each of one or more root nodes 200.

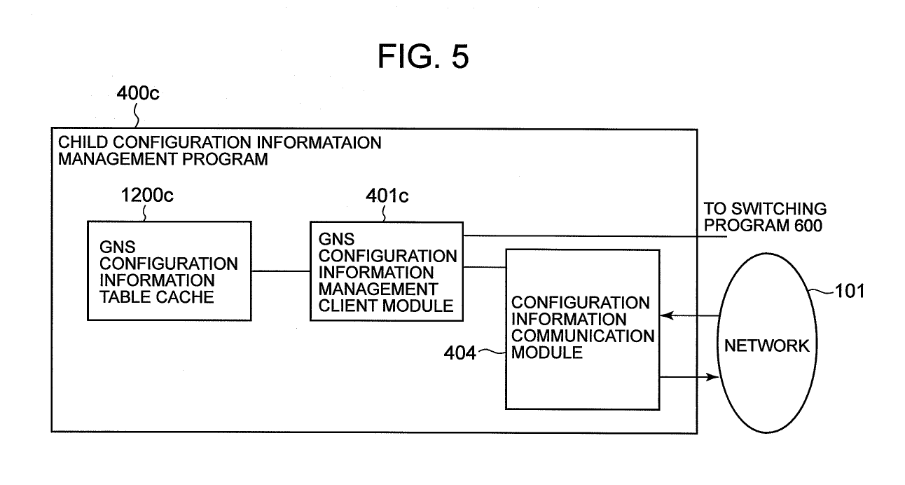

FIG. 5 is a block diagram showing an example of the constitution of a child configuration information management program 400c.

A child configuration information management program 400c comprises a GNS configuration information management client module 401c; and a configuration information communications module 404, and has a function for registering information in a GNS configuration information table cache 1200c.

A GNS configuration information table cache 1200c, for example, is prepared in the memory 202 (or a register of the processor 201). Information of basically the same content as that of the GNS configuration information table 1220p is registered in this cache 1200c. More specifically, the parent configuration information management program 400p notifies the contents of the GNS configuration information table 1200p to a child root node 200c, and the child configuration information management program 400c of the child root node 200c registers these notified contents in the GNS configuration information table cache.

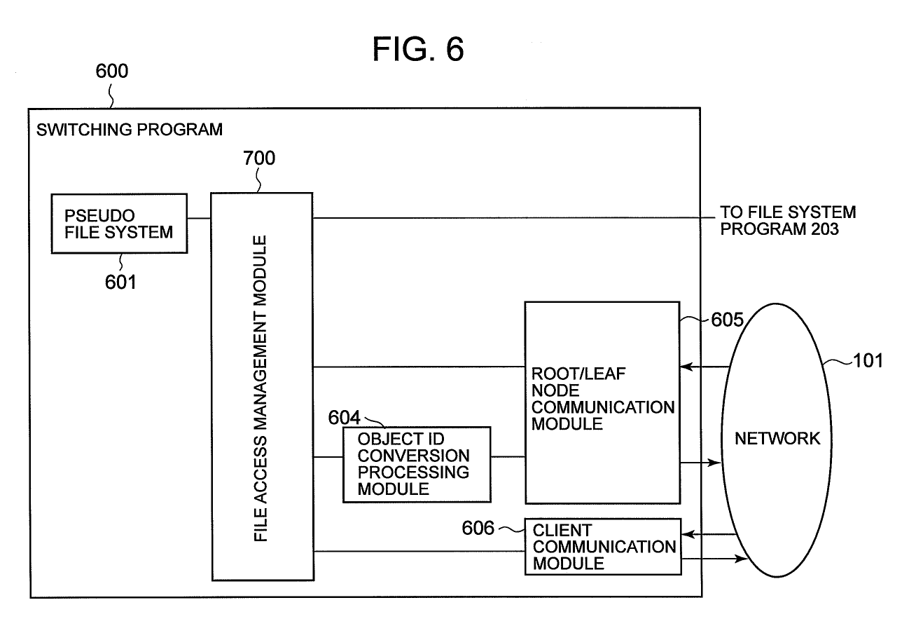

FIG. 6 is a block diagram showing an example of the constitution of the switching program 600.

The switching program 600 comprises a client communications module 606; an root/leaf node communications module 605; a file access management module 700; an object ID conversion processing module 604; and a pseudo file system 601.

The client communications module 606 receives a request (hereinafter, may also be called “request data”) from the client 100, and notifies the received request data to the file access management module 700. Further, the client communications module 606 sends the client 100 a response to the request data from the client 100 (hereinafter, may also be called “response data”) notified from the file access management module 700.

The root/leaf node communications module 605 sends data (request data from the client 100) outputted from the file access management module 700 to either the root node 200 or the leaf node 300. Further, the root/leaf node communications module 605 receives response data from either the root node 200 or the leaf node 300, and notifies the received response data to the file access management module 700.

The file access management module 700 analyzes request data notified from the client communications module 606, and decides the processing method for this request data. Then, based on the decided processing method, the file access management module 700 notifies this request data to the root/leaf node communications module 605. Further, when a request from the client 100 is a request for a file system 207 of its own (own local file system), the file access management module 700 creates response data, and notifies this response data to the client communications module 606. Details of the file access management module 700 will be explained hereinbelow.

The object ID conversion processing module 604 converts an object ID contained in request data received from the client 100 to a format that a leaf node 300 can recognize, and also converts an object ID contained in response data received from the leaf node 300 to a format that the client 100 can recognize. These conversions are executed based on algorithm information, which will be explained hereinbelow.

The pseudo file system 601 is for consolidating either all or a portion of the file system 207 of the root node 200 or the leaf node 300 to form a single pseudo file system. For example, a root directory and a prescribed directory are configured in the pseudo file system 601, and the pseudo file system 601 is created by mapping a directory managed by either the root node 200 or the leaf node 300 to this prescribed directory.

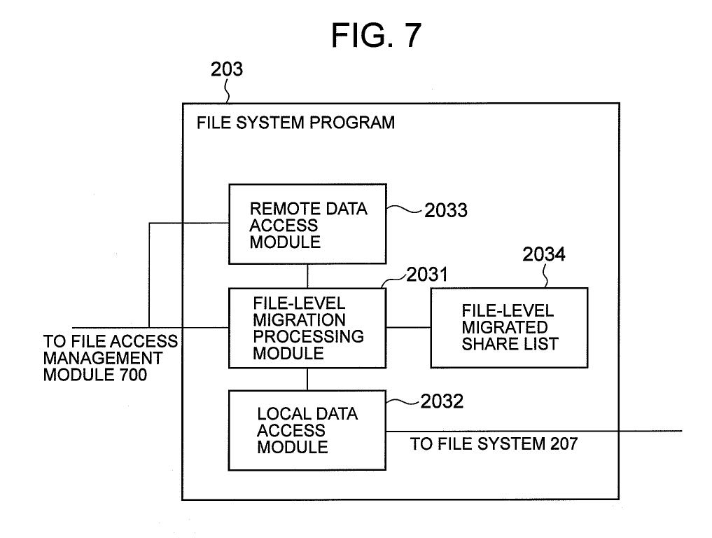

FIG. 7 is a block diagram showing an example of the constitution of a file system program 203.

The file system program 203 comprises a file-level migration processing module 2031; a local data access module 2032; a remote data access module 2033; and a file-level migrated share list 2034.

When the file access management module 700 determines that request data from a client 100 is for an object inside a file system 207 of its own (own local file system), the file-level migration processing module 2031 receives this request data from the file access management module 700. The file-level migration processing module 2031 analyzes the request data received from the file access management module 700, and when this request data is for a file that has not been migrated yet, the file-level migration processing module 2031 executes an operation conforming to this request data for the file inside the file system 207 by way of the local data access module 2032. Conversely, when this request data is for a migrated file, the file-level migration processing module 2031 sends the request data either to the migration-destination root node 200 or leaf node 300 by way of the remote data access module 2033.

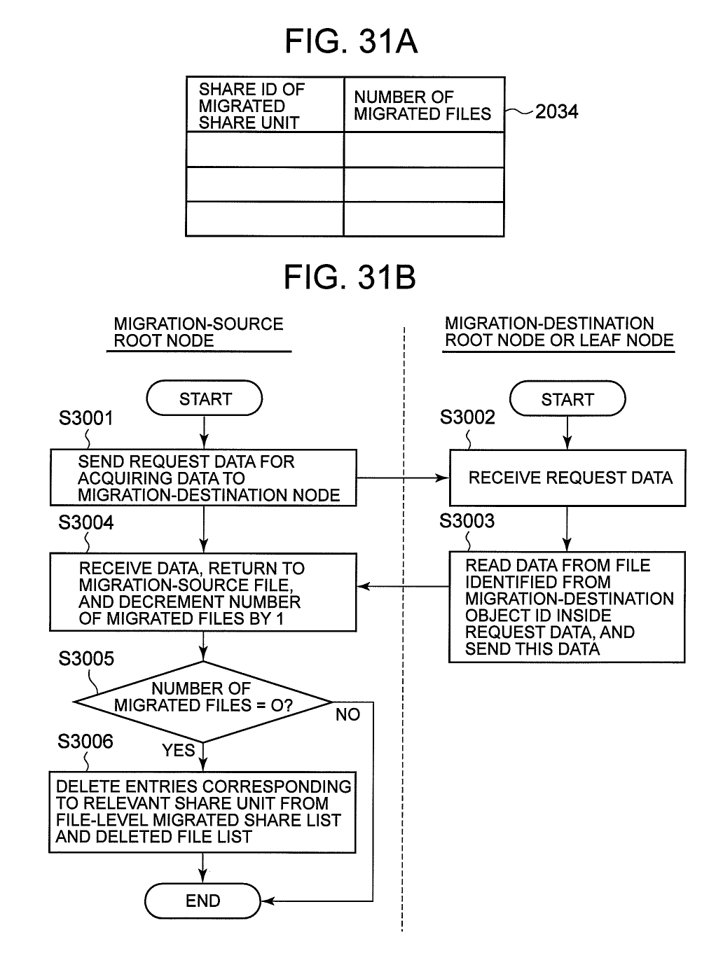

The file-level migrated share list 2034 is an electronic list, which maintains the share IDs of share units for which file-level data migration has been carried out to date. FIG. 31A shows an example of the constitution of the file-level migrated share list 2034. The file-level migrated share list 2034 contains an entry for each migrated share unit (a share unit comprising at least one migrated file), and each entry comprises a share ID corresponding to a migrated share unit, and a number of migrated files (files from which data has been migrated) comprised inside this migrated share unit. The file-level migrated share list 2034 is used by the file-level migration processing module 2031 to efficiently determine whether or not a request from the client 100 is for a migrated file.

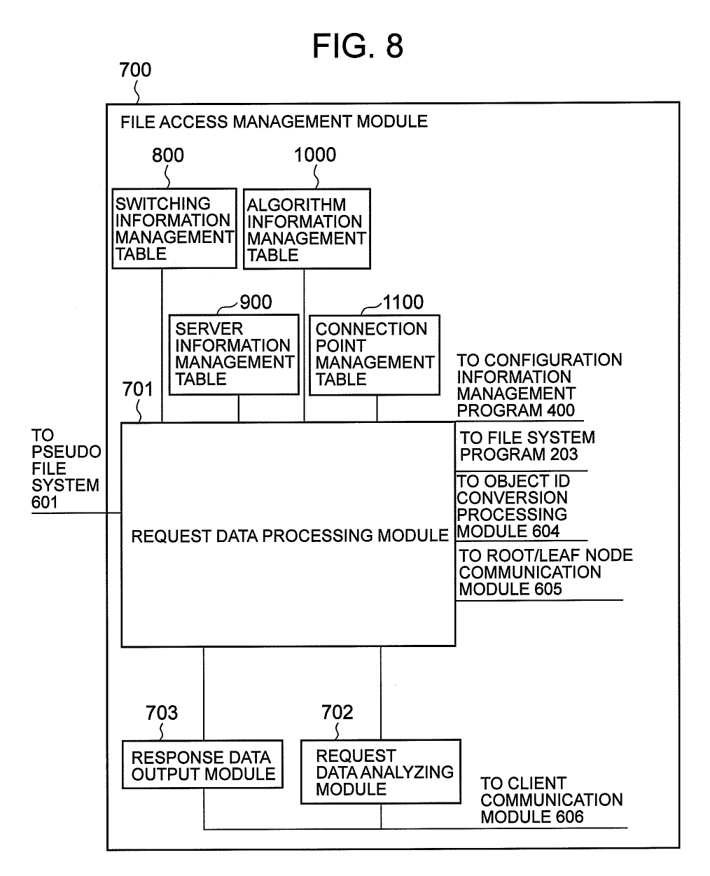

FIG. 8 is a block diagram showing an example of the constitution of the file access management module 700.

The file access management module 700 comprises a request data analyzing module 702; a request data processing module 701; and a response data output module 703, and has functions for referencing a switching information management table 800, a server information management table 900, an algorithm information management table 1000, and a connection point management table 1100.

The switching information management table 800, server information management table 900, algorithm information management table 1000, and connection point management table 1100 will be explained hereinbelow.

The request data analyzing module 702 analyzes request data notified from the client communications module 606. Then, the request data analyzing module 702 acquires the object ID from the notified request data, and acquires the share ID from this object ID.

The request data processing module 701 references arbitrary information from the switching information management table 800, server information management table 900, algorithm information management table 1000, and connection point management tablse 1100, and processes request data based on the share ID acquired by the request data analyzing module 702.

The response data output module 703 converts response data notified from the request data processing module 701 to a format to which the client 100 can respond, and outputs the reformatted response data to the client communications module 606.

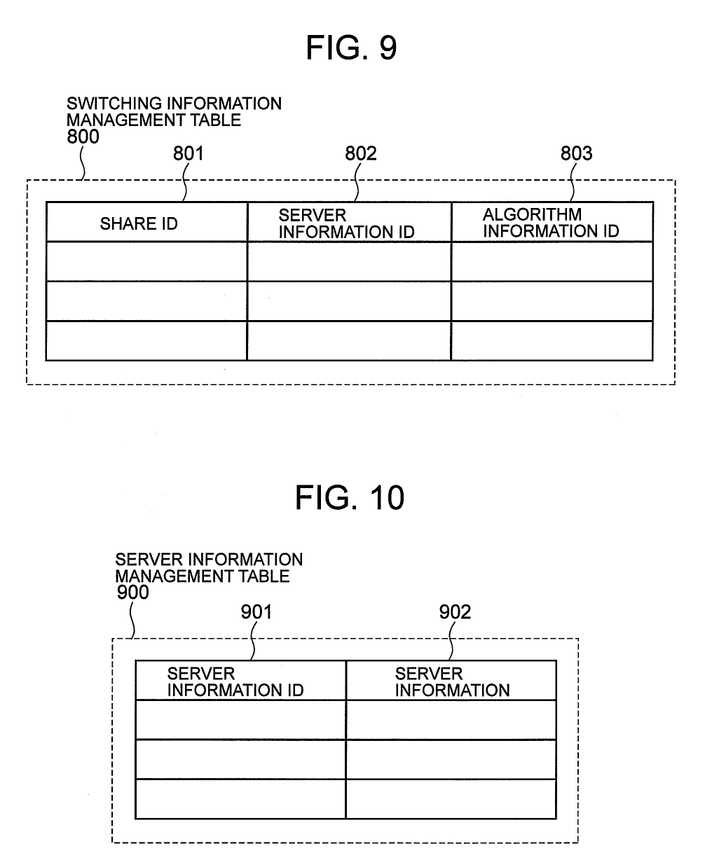

FIG. 9 is a diagram showing an example of the constitution of the switching information management table 800.

The switching information management table 800 is a table, which has entries constituting groups of a share ID 801, a server information ID 802, and an algorithm information ID 803. A share ID 801 is an ID for identifying a share unit. A server information ID 802 is an ID for identifying server information. An algorithm information ID 803 is an ID for identifying algorithm information. The root node 200 can acquire a server information ID 802 and an algorithm information ID 803 corresponding to a share ID 801, which coincides with a share ID acquired from an object ID. In this table 800, a plurality of groups of server information IDs 802 and algorithm information IDs 803 can be registered for a single share ID 801.

FIG. 10 is a diagram showing an example of the constitution of the server information management table 900.

The server information management table 900 is a table, which has entries constituting groups of a server information ID 901 and server information 902. Server information 902, for example, is the IP address or socket structure of the root node 200 or the leaf node 300. The root node 200 can acquire server information 902 corresponding to a server information ID 901 that coincides with an acquired server information ID 702, and from this server information 902, can specify the processing destination of a request from the client 100 (for example, the transfer destination).

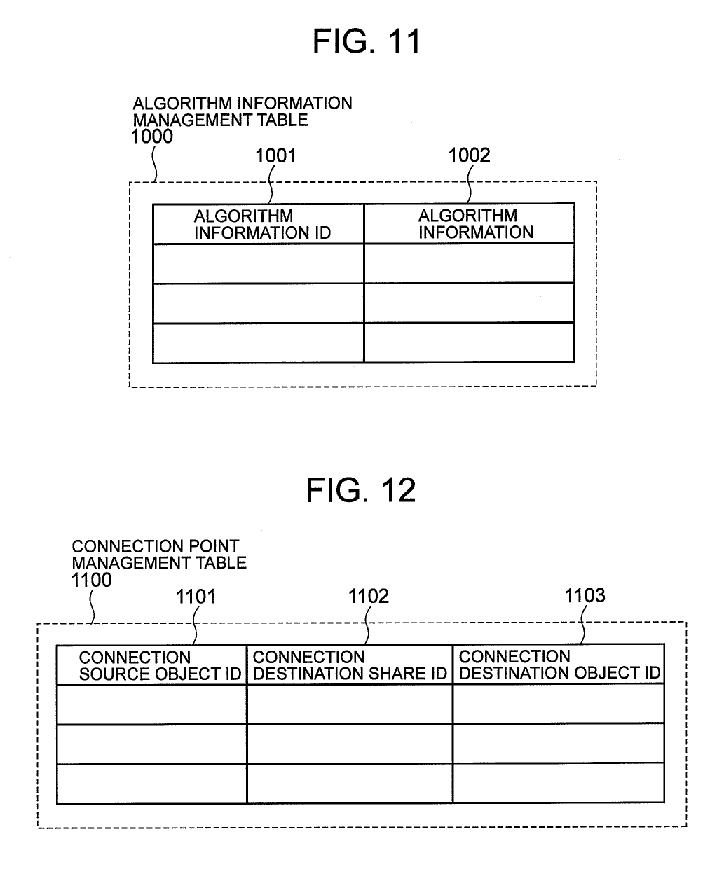

FIG. 11 is a diagram showing an example of the constitution of the algorithm information management table 1000.

The algorithm information management table 1000 is a table, which has entries constituting groups of an algorithm information ID 1001 and algorithm information 1002. Algorithm information 1002 is information showing an object ID conversion mode. The root node 200 can acquire algorithm information 1002 corresponding to an algorithm information ID 1001 that coincides with an acquired algorithm information ID 1001, and from this algorithm information 1002, can specify how an object ID is to be converted.

Furthermore, in this embodiment, the switching information management table 800, server information management table 900, and algorithm information management table 1000 are constituted as separate tables, but these can be constituted as a single table by including server information 902 and algorithm information 1002 in a switching information management table 800.

FIG. 12 is a diagram showing an example of the constitution of the connection point management table 1100.

The connection point management table 1100 is a table, which has entries constituting groups of a connection source object ID 1101, a connection destination share ID 1102, and a connection destination object ID 1103. By referencing this table, the root node 200 can just access a single share unit for the client 100 even when the access extends from a certain share unit to another share unit. Furthermore, the connection source object ID 1101 and connection destination object ID 1103 here are identifiers (for example, file handles or the like) for identifying an object, and can be exchanged with the client 100 by the root node 200, or can be such that an object is capable of being identified even without these object IDs 1101 and 1103 being exchanged between the two.

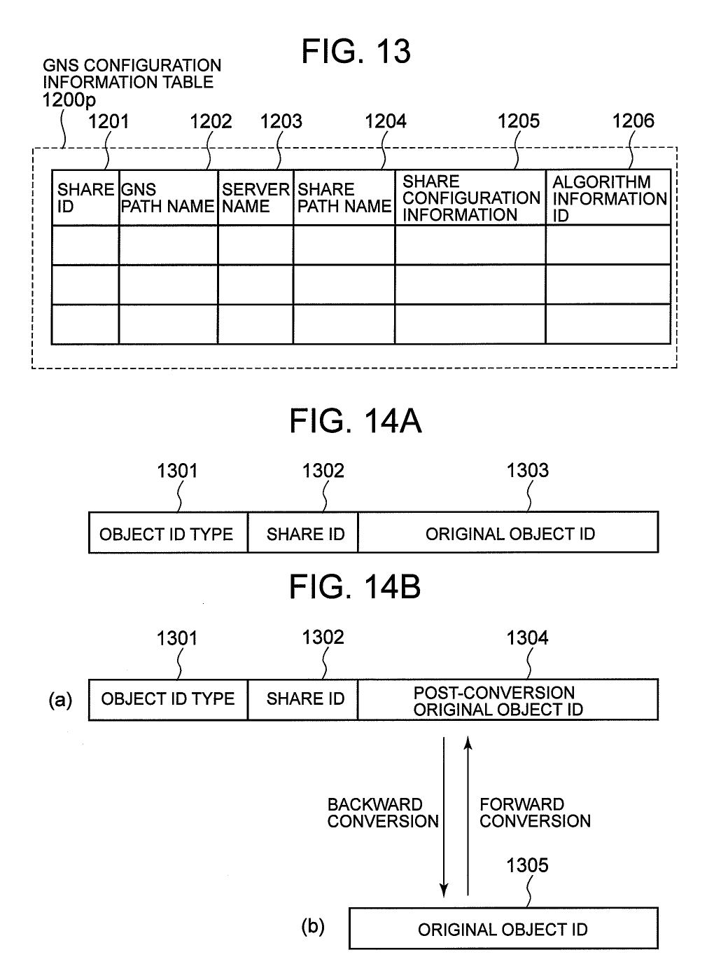

FIG. 13 is a diagram showing an example of the constitution of the GNS configuration information table 1200.

The GNS configuration information table 1200 is a table, which has entries constituting groups of a share ID 1201, a GNS path name 1202, a server name 1203, a share path name 1204, share configuration information 1205, and an algorithm information ID 1206. This table 1200, too, can have a plurality of entries comprising the same share ID 1201, the same as in the case of the switching information management table 800. The share ID 1201 is an ID for identifying a share unit. A GNS path name 1202 is a path for consolidating share units corresponding to the share ID 1201 in the GNS. The server name 1203 is a server name, which possesses a share unit corresponding to the share ID 1201. The share path name 1204 is a path name on the server of the share unit corresponding to the share ID 1201. Share configuration information 1205 is information related to a share unit corresponding to the share ID 1201 (for example, information set in the top directory (root directory) of a share unit, more specifically, for example, information for showing read only, or information related to limiting the hosts capable of access). An algorithm information ID 1206 is an identifier of algorithm information, which denotes how to carry out the conversion of an object ID of a share unit corresponding to the share ID 1201.

FIG. 14A is a diagram showing an example of an object ID exchanged in the case of an extended format OK. FIG. 14B is a diagram showing an object ID exchanged in the case of an extended format NG.

An extended format OK case is a case in which a leaf node 300 can interpret the object ID of share ID type format format, an extended format NG case is a case in which a leaf node 300 cannot interpret the object ID of share ID type format format, and in each case the object ID exchanged between devices is different.

Share ID type format format is format for an object ID, which extends an original object ID, and is prepared using three fields. An object ID type 1301, which is information showing the object ID type, is written in the first field. A share ID 1302 for identifying a share unit is written in the second field. In an extended format OK case, an original object ID 1303 is written in the third field as shown in FIG. 14A, and in an extended format NG case, a post-conversion original object ID 1304 is written in the third field as shown in FIG. 14B(a).

The root node 200 and some leaf nodes 300 can create an object ID having share ID type format format. In an extended format OK case, share ID type format format is used in exchanges between the client 100 and the root node 200, the root node 200 and a root node 200, and between the root node 200 and the leaf node 300, and the format of the object ID being exchanged does not change. As described hereinabove, in an extended format OK case, the original object ID 1303 is written in the third field, and this original object ID 1303 is an identifier (for example, a file ID) for either the root node 200 or the leaf node 300, which possesses the object, to identify this object in this root node 200 or leaf node 300.

Conversely, in an extended format NG case, an object ID having share ID type format as shown in FIG. 14B(a) is exchanged between the client 100 and the root node 200, and between the root node 200 and a root node 200, and a post-conversion original object ID 1304 is written in the third field as described above. Then, an exchange is carried out between the root node 200 and the leaf node 300 using an original object ID 1305 capable of being interpreted by the leaf node 300 as shown in FIG. 14B(b). That is, in an extended format NG case, upon receiving an original object ID 1305 from the leaf node 300, the root node 200 carries out a forward conversion, which converts this original object ID 1305 to information (a post-conversion object ID 1304) for recording in the third field of the share ID type format. Further, upon receiving an object ID having share ID type format, a root node 200 carries out backward conversion, which converts the information written in the third field to the original object ID 1305. Both forward conversion and backward conversion are carried out based on the above-mentioned algorithm information 1002.

More specifically, for example, the post-conversion original object ID 1304 is either the original object ID 1305 itself, or is the result of conversion processing being executed on the basis of algorithm information 1002 for either all or a portion of the original object ID 1305. For example, if the object ID is a variable length, and a length, which adds the length of the first and second fields to the length of the original object ID 1305, is not more than the maximum length of the object ID, the original object ID 1305 can be written into the third field as the post-conversion original object ID 1304. Conversely, for example, when the data length of the object ID is a fixed length, and this fixed length is exceeded by adding the object ID type 1301 and the share ID 1302, conversion processing is executed for either all or a portion of the original object ID 1305 based on the algorithm information 1002. In this case, for example, the post-conversion original object ID 1304 is converted so as to become shorter that the data length of the original object ID 1305 by deleting unnecessary data.

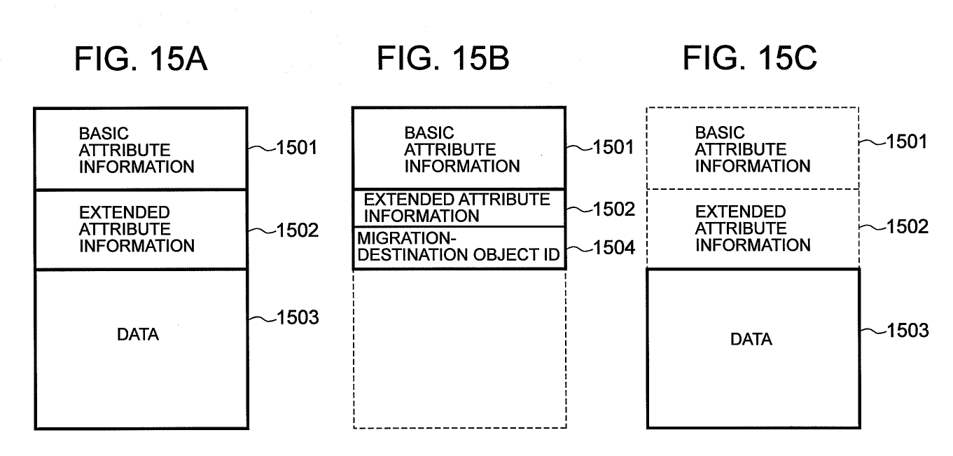

FIG. 15A shows an example of a file for which data migration processing has not been carried out.

A file for which a data migration process has not been carried out constitutes basic attribute information 1501, extended attribute information 1502, and data 1503. Basic attribute information 1501 is attribute information specific to the file system, such as file permission, and last access date/time. Extended attribute information 1502 is independently defined attribute information that differs from the file system-specific attribute information. The data 1503 is the actual data constituting the content of the file.

FIG. 15B shows an example of a file for which data migration processing has been carried out.

A file for which data migration processing has been carried out (migration-source file) constitutes basic attribute information 1501 and extended attribute information 1502, but does not constitute data 1503 (that is, it becomes a so-called stub file). As will be explained hereinbelow, this is because the data 1503 is deleted from the file after being migrated. The basic attribute information 1501 is also used subsequent to data migration processing the same as prior to data migration processing. The migration-destination object ID 1504 is stored in the extended attribute information 1502 at data migration processing. Furthermore, FIG. 15B is an example, and, for example, the extended attribute information 1502 can also be done away with. In this case, for example, the corresponding relationship between the relevant file and the migration-destination object ID 1504 can be stored in a storage resource, such as the storage unit 206.

FIG. 15C shows an example of a data migration-destination file.

A data migration-destination file constitutes basic attribute information 1501, extended attribute information 1502, and data 1503, but only the data 1503 is actually utilized.

Next, the operation of the root node 200 will be explained. As described hereinabove, the root node 200 consolidates a plurality of share units to form a single pseudo file system, that is, the root node 200 provides the GNS to the client 100.

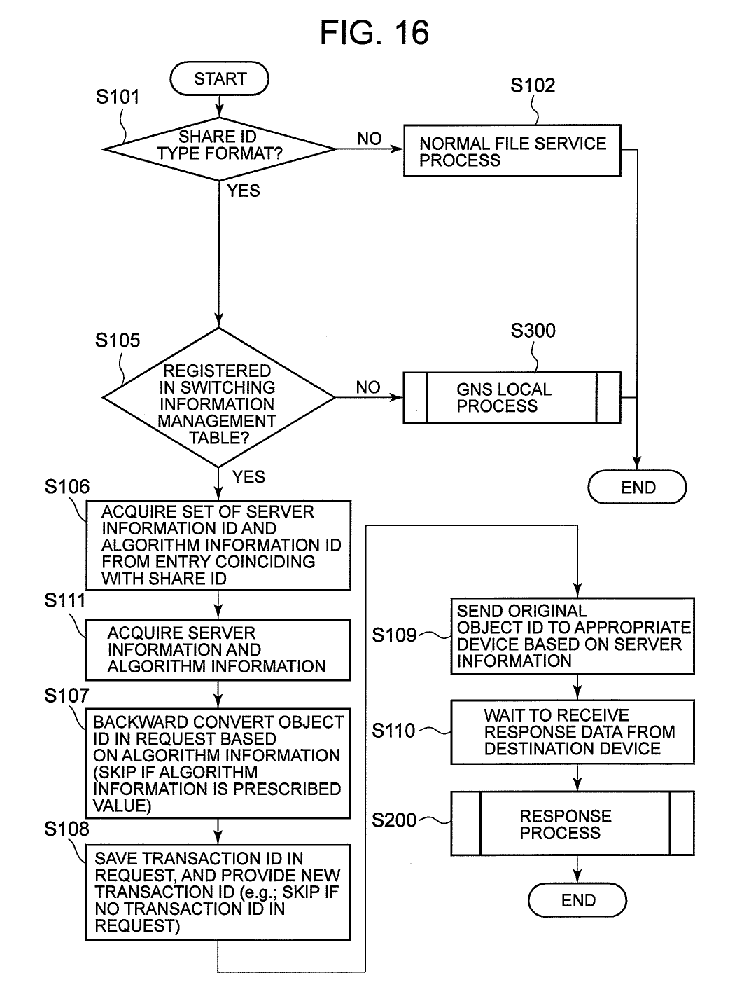

FIG. 16 is a flowchart of processing in which the root node 200 provides the GNS.

First, the client communications module 606 receives from the client 100 request data comprising an access request for an object. The request data comprises an object ID for identifying the access-targeted object. The client communications module 606 notifies the received request data to the file access management module 700. The object access request, for example, is carried out using a remote procedure call (RPC) of the NFS protocol. The file access management module 700, which receives the request data notification, extracts the object ID from the request data. Then, the file access management module 700 references the object ID type 1301 of the object ID, and determines whether or not the format of this object ID is share ID type format (S101).

When the object ID type is not share ID type format (S101: NO), conventional file service processing is executed (S102), and thereafter, processing is ended.

When the object ID type is share ID type format (S101: YES), the file access management module 700 acquires the share ID 1302 contained in the extracted object ID. Then, the file access management module 700 determines whether or not there is a share ID that coincides with the acquired share ID 1302 among the share IDs registered in the access suspending share ID list 704 (S103). As described hereinabove, a plurality of entries coinciding with the acquired share ID 1302 can exist for share ID 801.

When there is no matching entry (S105: NO), a determination is made that this root node 200 should process the received request data, the file system program 203 is executed, and GNS local processing is executed (S300). GNS local processing will be explained in detail hereinbelow.

When there is a matching entry (S105: YES), a determination is made that a device other than this root node 200 should process the received request data, and a group of one set of a server information ID 802 and algorithm information ID 803 is acquired from the coinciding share ID 801 entry (S106). When there is a plurality of coinciding entries, for example, one entry is selected either in round-robin fashion, or on the basis of a previously calculated response time, and a server information ID 802 and algorithm information ID 803 are acquired from this selected entry.

Next, the file access management module 700 references the server information management table 900, and acquires server information 902 corresponding to a server information ID 901 that coincides with the acquired server information ID 802. Similarly, the file access management module 700 references the algorithm information management table 1000, and acquires algorithm information 1002 corresponding to an algorithm information ID 1001 that coincides with the acquired algorithm information ID 803 (S111).

Thereafter, if the algorithm information 1002 is not a prescribed value (for example, a value of 0), the file access management module 700 indicates that the object ID conversion processing module 604 carry out a backward conversion based on the acquired algorithm information 1002 (S107), and conversely, if the algorithm information 1002 is a prescribed value, the file access management module 700 skips this S107. In this embodiment, the fact that the algorithm information 1002 is a prescribed value signifies that request data is transferred to another root node 200. That is, in the transfer between root nodes 200, the request data is simply transferred without having any conversion processing executed. That is, the algorithm information 1002 is information signifying an algorithm that does not make any conversion at all (that is, the above prescribed value), or information showing an algorithm that only adds or deletes an object ID type 1301 and share ID 1302, or information showing an algorithm, which either adds or deletes an object ID type 1301 and share ID 1302, and, furthermore, which restores the original object ID 1303 from the post-conversion original object ID 1304.

Next, when the protocol is for executing transaction processing at the file access request level, and the request data comprises a transaction ID, the file access management module 700 saves this transaction ID, and provides the transaction ID to either the root node 200 or the leaf node 300, which is the request data transfer destination device (S108) Either transfer destination node 200 or 300 can reference the server information management table 900, and can identify server information from the server information 902 corresponding to the server information ID 901 of the acquired group. Furthermore, if the above condition is not met (for example, when a transaction ID is not contained in the request data), the file access management module 700 can skip this S108.

Next, the file access management module 700 sends via the root/leaf node communications module 605 to either node 200 or 300, which was specified based on the server information 902 acquired in S111, the received request data itself, or request data comprising the original object ID 1305 (S109). Thereafter, the root/leaf node communications module 605 waits to receive response data from the destination device (S110).

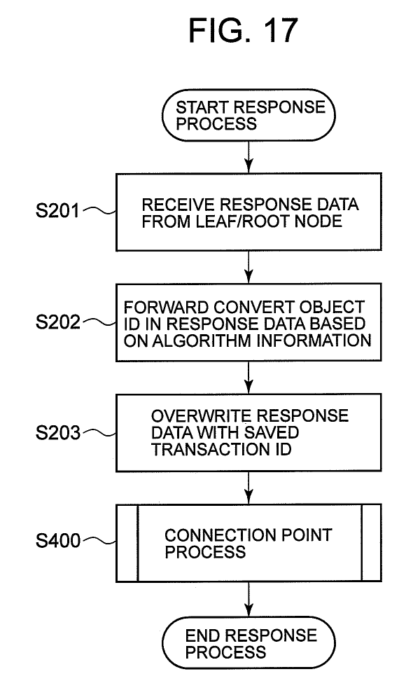

Upon receiving the response data, the root/leaf node communications module 605 executes response processing (S200) Response processing will be explained in detail using FIG. 17.

FIG. 17 is a flowchart of processing (response processing) when the root node 200 receives response data.

The root/leaf node communications module 605 receives response data from either the leaf node 300 or from another root node 200 (S201). The root/leaf node communications module 605 notifies the received response data to the file access management module 700.

When there is an object ID in the response data, the file access management module 700 indicates that the object ID conversion processing module 604 convert the object ID contained in the response data. The object ID conversion processing module 604, which receives the indication, carries out forward conversion on the object ID based on the algorithm information 1002 referenced in S107 (S202). If this algorithm information 1002 is a prescribed value, this S202 is skipped.

When the protocol is for carrying out transaction management at the file access request level, and the response data comprises a transaction ID, the file access management module 700 overwrites the response message with the transaction ID saved in S108 (S203). Furthermore, when the above condition is not met (for example, when a transaction ID is not contained in the response data), this S203 can be skipped.

Thereafter, the file access management module 700 executes connection point processing, which is processing for an access that extends across share units (S400). Connection point processing will be explained in detail below.

Thereafter, the file access management module 700 sends the response data to the client 100 via the client communications module 606, and ends response processing.

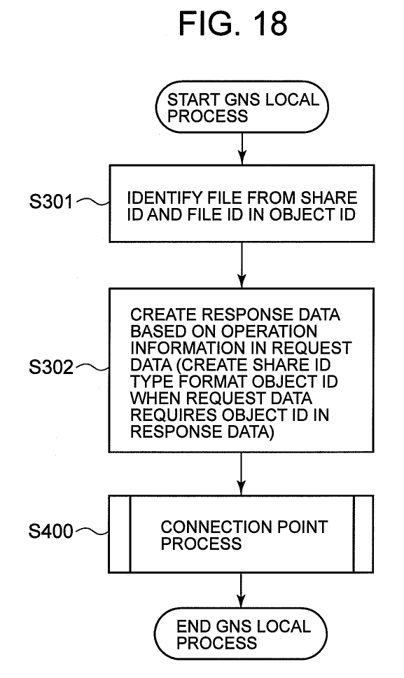

FIG. 18 is a flowchart of GNS local processing executed by the root node 200.

First, an access-targeted object is identified from the share ID 1302 and original object ID 1303 in an object ID extracted from request data (S301).

Next, response data is created based on information, which is contained in the request data, and which denotes an operation for an object (for example, a file write or read) (S302). When it is necessary to include the object ID in the response data, the same format as the received format is utilized in the format of this object ID.

Thereafter, connection point processing is executed by the file access management module 700 of the switching program 600 (S400).

Thereafter, the response data is sent to the client 100.

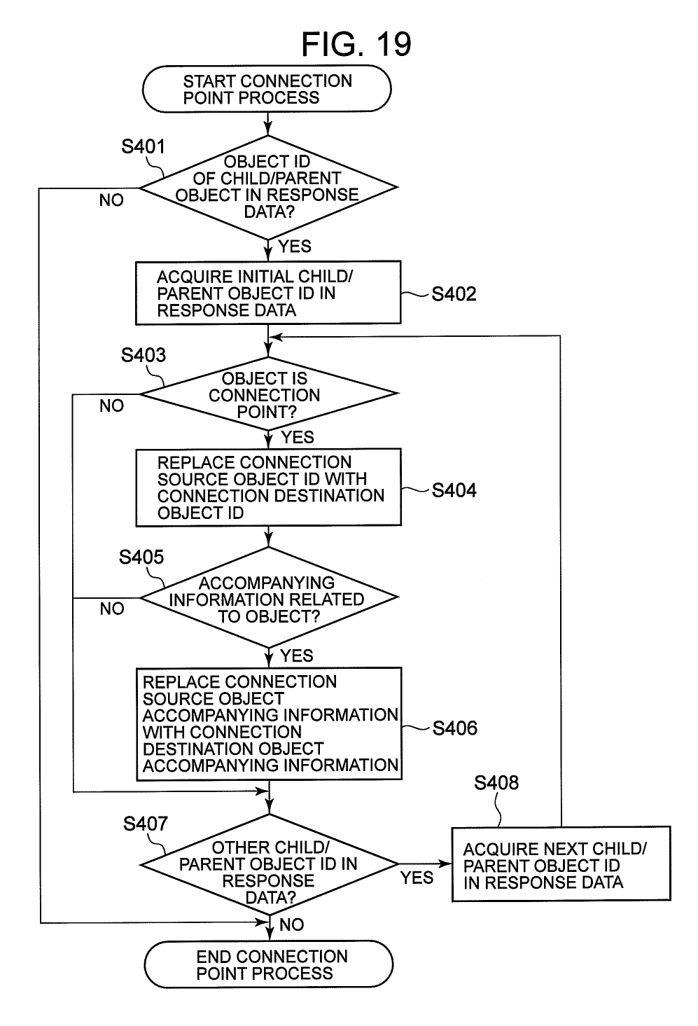

FIG. 19 is a flowchart of connection point processing executed by the root node 200.

First, the file access management module 700 checks the access-targeted object specified by the object access request (request data), and ascertains whether or not the response data comprises one or more object IDs of either a child object (a lower-level object of the access-targeted object in the directory tree) or a parent object (a higher-level object of the access-targeted object in the directory tree) of this object (S401). Response data, which comprises an object ID of a child object or parent object like this, for example, corresponds to response data of a LOOKUP procedure, READDIR procedure, or READDIRPLUS procedure under the NFS protocol. When the response data does not comprise an object ID of either a child object or a parent object (S401: NO), processing is ended.

When the response data comprises one or more object IDs of either a child object or a parent object (S401: YES), the file access management module 700 selects the object ID of either one child object or one parent object in the response data (S402).

Then, the file access management module 700 references the connection point management table 1100, and determines if the object of the selected object ID is a connection point (S403) More specifically, the file access management module 700 determines whether or not the connection source object ID 1101 of this entry, of the entries registered in the connection point management table 1100, coincides with the selected object ID.

If there is no coinciding entry (S403: NO), the file access management module 700 ascertains whether or not the response data comprises an object ID of another child object or parent object, which has yet to be selected (S407). If the response data does not comprise the object ID of any other child object or parent object (S407: NO), connection point processing is ended. If the response data does comprise the object ID of either another child object or parent object (S407: YES), the object ID of one as-yet-unselected either child object or parent object is selected (S408). Then, processing is executed once again from S403.

If there is a coinciding entry (S403: YES), the object ID in this response data is substituted for the connection destination object ID 1103 corresponding to the connection source object ID 1101 that coincides therewith (S404).

Next, the file access management module 700 determines whether or not there is accompanying information related to the object of the selected object ID (S405). Accompanying information, for example, is information showing an attribute related to this object. When there is no accompanying information (S405: NO), processing moves to S407. When there is accompanying information (S405: YES), the accompanying information of the connection source object is replaced with the accompanying information of the connection destination object (S406), and processing moves to S407.

The modules related to data migration in this embodiment will be explained in particular detail hereinbelow.

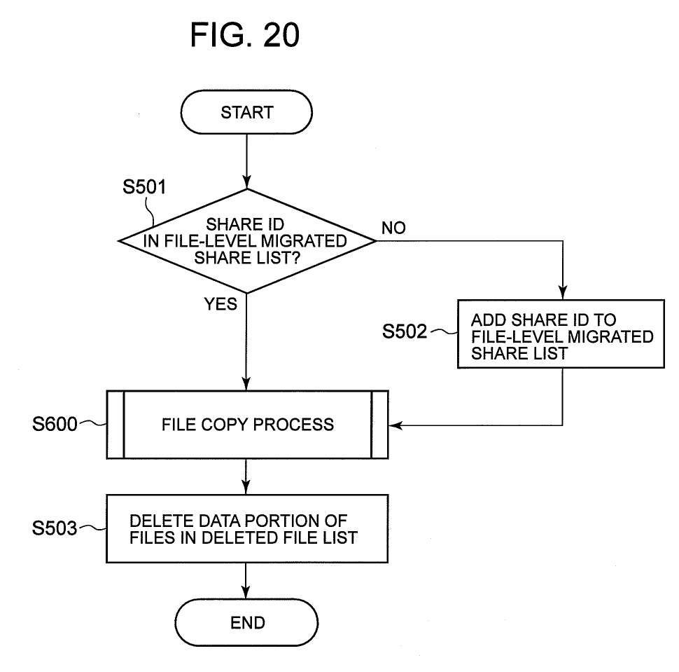

FIG. 20 is a flowchart of data migration processing carried out by the data migration program 4203 executed by the root node 200.

A data migration process, for example, is started by an administrator specifying either an arbitrary directory tree or file, and issuing an indication to the root node 200. Furthermore, the commencement of a data migration process can also be started automatically when a file or file system transitions to a specific state. A specific state of a file or file system, for example, refers to a situation in which a prescribed period of time has passed from the time a file was last accessed until the current time, or a situation in which the capacity of a file system exceeds a prescribed capacity.

When a data migration process is started, the data migration program 4203 acquires the share ID of the share unit of the migration-targeted directory tree or file, and determines if the acquired share ID exists in the file-level migrated share list 2034 (S501).

When the acquired share ID does not exist in the file-level migrated share list 2034 (S501: NO), the data migration program 4203 adds the acquired share ID to the file-level migrated share list 2034 (S502), and shifts to a file copy process (S600).

When the acquired share ID does exist in the file-level migrated share list 2034 (S501: YES), the data migration program 4203 directly carries out file copy processing (S600). The file copy process will be explained in detail hereinbelow.

Subsequent to file copy processing, the data migration program 4203 deletes the data 1503 from the respective files identified from the respective file identification information (for example, either the migration-source object ID or the file pathname) registered in the deleted file list (not shown in the figure) (S503). The deleted file list is an electronic list prepared during file copy processing. Furthermore, even though the data 1503 is deleted from the file, the file size in the basic attribute information 1501 inside the file need not be updated.

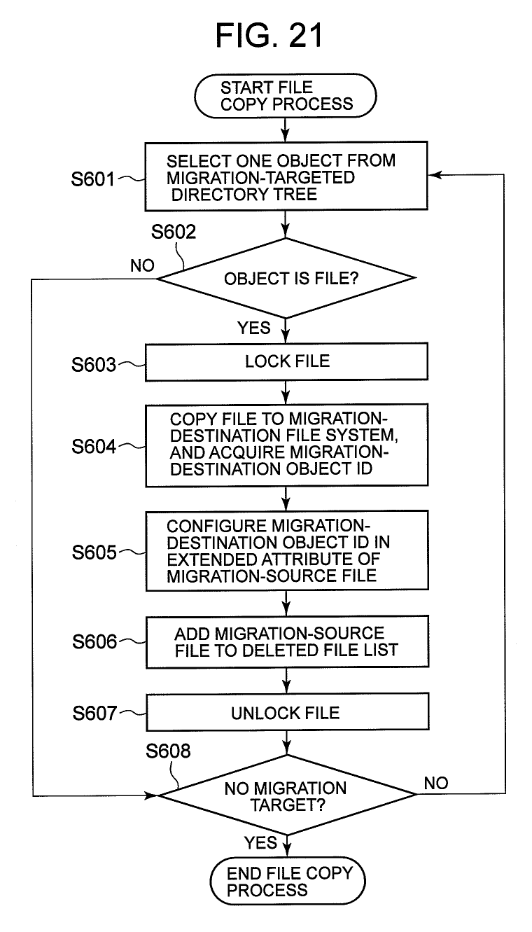

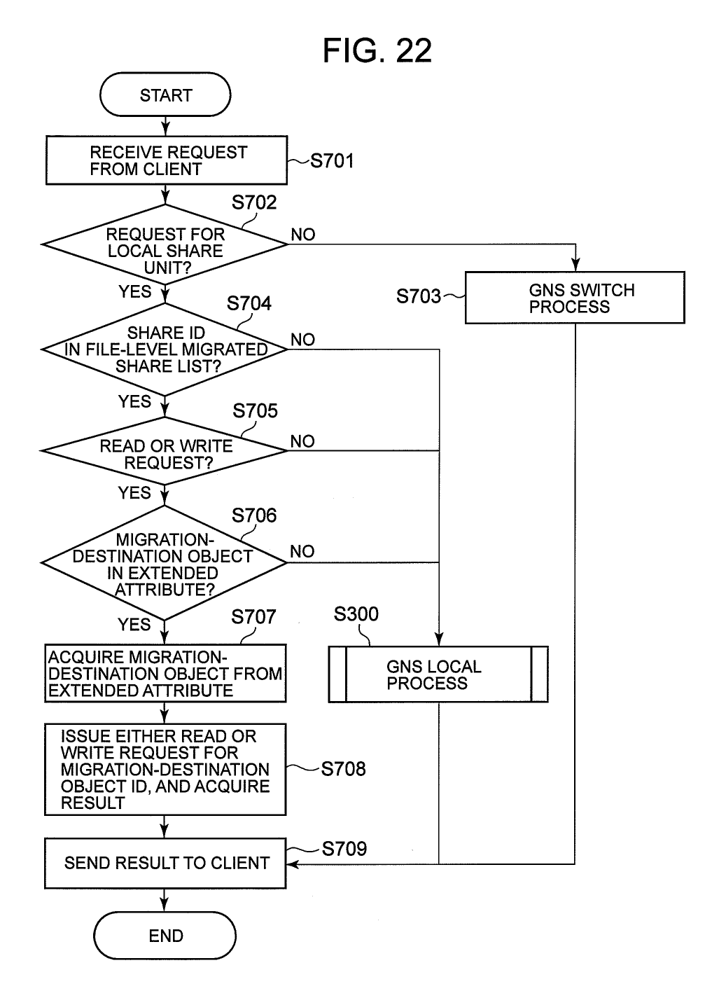

FIG. 21 is a flowchart of file copy processing carried out by the data migration program 4203 executed by the root node 200.

First, the data migration program 4203 selects one object from the migration-targeted directory tree (S601).

Next, the data migration program 4203 determines whether or not the object selected in S601 is a file (S602).

When the object is a file (S602: YES), the data migration program 4203 locks this file (the file selected in S601 will be called the “selected file” in the explanation of FIG. 21 hereinbelow) (S603). More specifically, for example, the data migration program 4203 changes a logical value, which denotes a flag for exclusive access control corresponding to the selected file, from “0” to “1”. Consequently, the selected file is prevented from being updated.

Then, the data migration program 4203 copies the selected file to the migration-destination file system (either file system 207 or 307 inside either migration-destination root node 200 or leaf node 300), and acquires the migration-destination object ID (S604). More specifically, for example, the data migration program 4203 reads the data 1503 from the selected file, sends the read-out data 1503 to either the migration-destination root node 200 or leaf node 300, and, in response thereto, receives from either the migration-destination root node 200 or leaf node 300 the migration-destination object ID, which is an object ID for identifying the migration-destination file (the file comprising the sent data 1503) in the migration-destination file system. The migration-destination object ID is created by either file system program 203 or 303 executed by either the migration-destination root node 200 or leaf node 300. For example, when the migration destination is the root node 200 here, a migration-destination object ID comprising a share ID is created. Conversely, when either the migration-destination root node 200 or leaf node 300 does not interpret the object ID of the share ID type format, a migration-destination object ID, which does not comprise a share ID, is created, and in this case, as will be explained hereinbelow, an object ID conversion processing module 602 creates and stores an object ID comprising a share ID by subjected this migration-destination object ID to conversion processing based on algorithm information 1102.

The data migration program 4203 stores the migration-destination object ID by including the acquired migration-destination object ID in the extended attribute information 1502 of the selected file (migration-source file) (S605). At this point, the stored migration-destination object ID is a share ID type format object ID. That is, when neither the migration-destination root node 200 nor leaf node 300 interprets the object ID of the share ID type format, the object ID conversion processing module 602 stores the object ID subsequent to carrying out conversion processing based on the algorithm information 1102.

Then, the data migration program 4203 registers the identifier of the selected file (migration-source file) in the deleted file list, and subsequent to incrementing by 1 the number of migrated files of the file-level migrated share list 2034 (S606), unlocks the selected file (S607). Furthermore, this deleted file list is an electronic list, which maintains information (for example, an object ID and file pathname) for identifying a deletion-targeted file.

Next, the data migration program 4203 determines if there is a migration target besides this selected file (S608). This S608 is carried out even when the object selected in S601 is not a file (S602: NO). When there is no migration target (S608: YES), the data migration program 4203 ends the file copy process. When there is another migration target (S608: NO), the data migration program 4203 returns to S601, and selects the next object.

FIG. 31B shows the flow of processing carried out for returning data in a migration-destination file to the migration-source file.

In the root node (migration-source root node) 200, which manages the share unit comprising the migration-source file, the data migration program 4203 sends request data comprising the migration-destination object ID (request data denoting that data will be returned to the migration-source file) to either the migration-destination root node 200 or leaf node 300 (S3001) Either the migration-destination root node 200 or leaf node 300 is specified by the following process. That is, the server ID corresponding to the share ID inside the migration-destination object ID is specified by referencing the switching information management table 800, the server information corresponding to this server ID is specified by referencing the server information management table 900, and either the migration-destination root node 200 or leaf node 300 is specified based on this server information.

Either the switching program 600 in the migration-destination root node 200, or the file service program 308 in the migration-destination leaf node 300 receives request data (S3002), and either file system program 203 or 303 of either the root node 200 or the leaf node 300 reads out the data 1503 from the migration-destination file identified from the migration-destination object ID of this request data, and either the switching program 600 in the migration-destination root node 200, or the file service program 308 in the migration-destination leaf node 300 sends the read-out data 1503 to the migration-source root node 200 (S3003).

In the migration-source root node 200, the data migration program 4203 receives the data 1503 from either the migration-destination root node 200 or leaf node 300, stores the received data 1503 in the migration-source file, and decrements by 1 the number of migrated files corresponding to the share unit comprising this migration-source file (the number of migrated files registered in the file-level migrated share list 2034) (S3004). If the result is that the number of migrated files is 0 (S3005: YES), this share unit does not comprise a migrated file, and the data migration program 4203 deletes the entry corresponding to this share unit from the file-level migrated share list 2034 and the deleted file list (S3006).

According to the flow of processing described hereinabove, in brief, the data migration program 4203 can recover migration-source file data 1503 from the migration-destination file. When the data 1503 has been returned to all of the migrated files (migration-source files) inside the share unit managed by the root node 200, this share unit ceases to be a migrated share unit because the entries comprising the share ID for identifying this share unit are deleted from the file-level migrated share list 2034 and deleted file list.

FIG. 22 is a flowchart of processing carried out by the root node 200, which receives request data from the client 100.

First, the client communication module 606 receives from the client 100 request data denoting an access request for an object (S701). The request data comprises an object ID for identifying the access-targeted object. The client communication module 606 determines from the share ID inside this object ID (hereinafter, referred to as the “specified share ID” in the explanation of FIG. 22) if the request data is for an object inside a local share unit or an object inside a remote share unit (S702). Furthermore, the operations up to this point are the same as the operations up to S103 in the flowchart of GNS-provision processing of FIG. 16.

If the request data is for an object inside a remote share unit (S702: NO), a GNS switching process is carried out (S703) The GNS switching process is the same processing as S104 through S200.

If the request data is for an object inside a local share unit (S702: YES), the file-level migration processing module 2031 determines if the specified share ID exists in the file-level migrated share list 2034 (S704).

If the specified share ID exists in the file-level migrated share list 2034 (S704: YES), the file-level migration processing module 2031 determines if the request data is a read request or a write request (S705).

When the request data is either a read request or a write request (S705: YES), the file-level migration processing module 2031 identifies the file from the object ID of this request data, and determines if the migration-destination object ID exists in the extended attribute information 1502 of this file (S706).

When the migration-destination object ID exists in the extended attribute information 1502 of this file (S706: YES), the file-level migration processing module 2031 acquires this migration-destination object ID (S707). Upon receiving an indication from the file-level migration processing module 2031, the remote data access module 2033 issues to either the migration-destination root node 200 or leaf node 300 request data in which the object ID in this request data is rewritten to the acquired migration-destination object ID, and acquires the result (S708). The process for issuing request data to either the migration-destination root node 200 or leaf node 300 is the same processing as the flowchart for the GNS-provision processing of FIG. 16.

As shown in S705 and S708, only a read request and a write request from among the request data from the client 100 is transferred to either the migration-destination root node 200 or leaf node 300. That is, in the case of request data (for example, a GETATTR request or the like when the file sharing protocol is NFS) for accessing only the attribute information inside a file (either basic attribute information 1501 or extended attribute information 1502), the file system program 203 uses the attribute information of the migration-source file, issues a response, and does not access either the migration-destination root node 200 or leaf node 300 (does not transfer the request data). Further, when the attribute information inside the migration-source file (attribute information, such as the last access time, file size, and so forth) is altered as the result of a read request and write request transferred to either the migration-destination root node 200 or leaf node 300, the file system program 203 changes the attribute information inside the migration-source file, and thereafter, sends response data to the client 100.

When the specified share ID does not exist in the file-level migrated share list (S704: NO), when the request data is neither a read request nor a write request (S705: NO), and when the migration-destination object ID does not exist in the extended attribute information 1502 inside the file (S706: NO), GNS local processing is carried out (S300).

Subsequent to the completion of any one of S703, S300, or S708, the switching program 600 responds to the client 100 with the result, and ends processing (S709).

According to this embodiment, the migration-source switching program 600 and the file system program 203 carry out a virtualization process, which makes it possible for the client 100 to access a migration-destination file using a migration-source object ID. Further, the corresponding relationship between the migration-source file object ID and the migration-destination file object ID needed for this is maintained by the migration-source file system 207 by virtue of the migration-destination object ID being included in the attribute information inside the migration-source file. For this reason, it is not necessary to synchronize the corresponding relationship of the migration-source file object ID and the migration-destination file object ID between the nodes. In addition, in this embodiment, a determination is made at the share unit level as to whether or not request data from the client 100 is for a migrated file. For these reasons, it is possible to realize high scalability, and file-level data migration (data migration in file units and directory units), which moderates drops in performance during request transfer processing.

### Second Embodiment

Next, a second embodiment of the present invention will be explained. The following explanation will focus primarily on the differences with the first embodiment, and explanations of the points in common with the first embodiment will be either simplified or omitted.

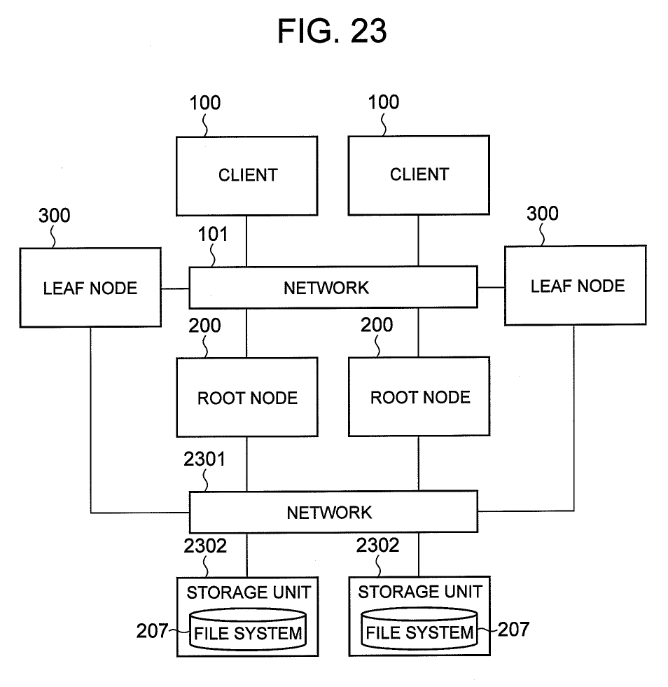

FIG. 23 is a diagram showing an example of the constitution of a computer system comprising a root node related to a second embodiment of the present invention.

A computer system related to the second embodiment further comprises a network 2301 and a storage unit 2302 in addition to the components comprising the computer system of FIG. 1.

The network 2301 is a dedicated communication network for connecting the root node 200 and leaf node 300, and the storage unit 2302, and differs from network 101. This network 2301, for example, is a SAN (Storage Area Network).

The storage unit 2302 is used by the root node 200 and leaf node 300 via network 2301, and, for example, corresponds to a storage system comprising a plurality of media drives (for example, hard disk drives or flash memory drives).

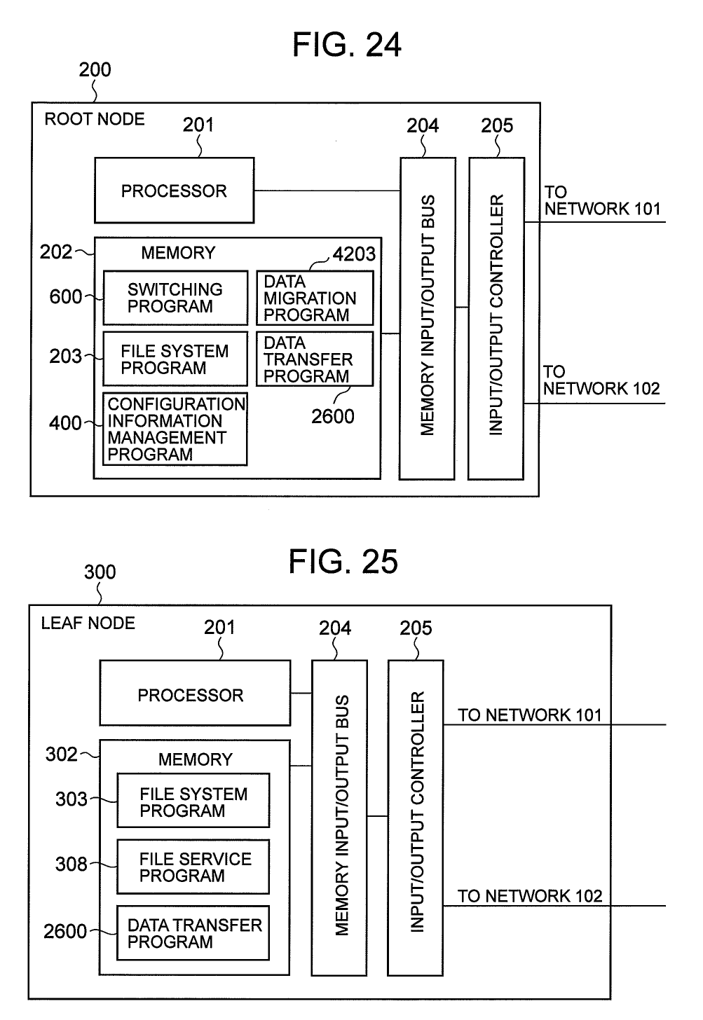

The root node 200 and leaf node 300 of the second embodiment further comprise a data transfer program 2600 like that shown in FIGS. 24 and 25, respectively.

The data transfer program 2600 has a parent data transfer program 2600p and a child data transfer program 2600c, and the root node 200 comprises either one or both of these programs, while the leaf node 300 comprises the child data transfer program 2600c.

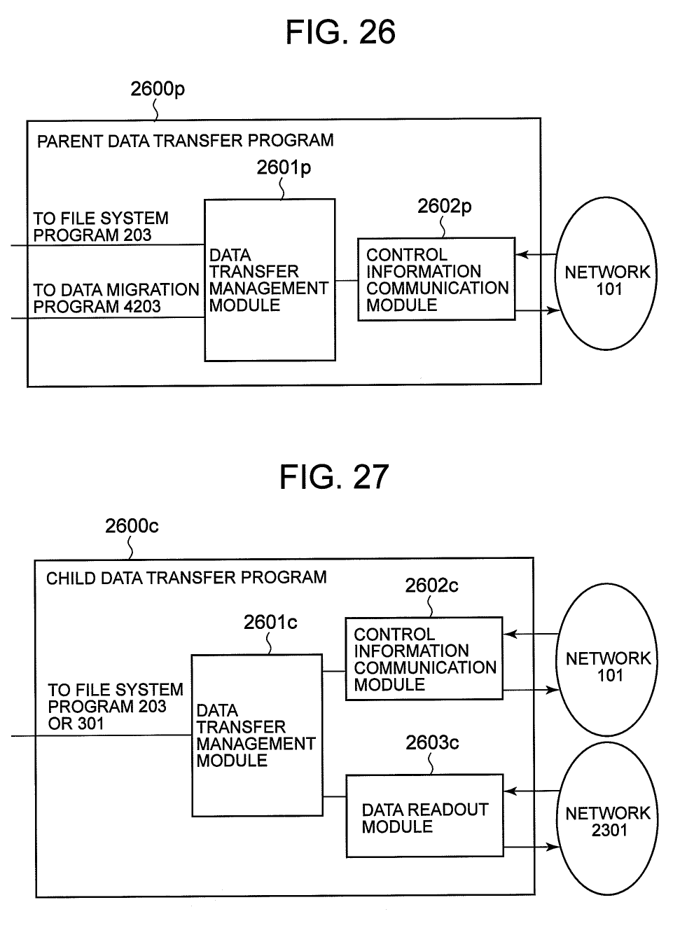

FIG. 26 is a block diagram showing an example of the constitution of the parent data transfer program 2600p.

The parent data transfer program 2600p comprises a data transfer management module 2601p and a control information communication module 2602p.

The data transfer management module 2601p receives an indication from the data migration program 4203, and exercises control over a data transfer. The control information communication module 2602p communicates with the child data transfer program 2600c, and transmits and receives control information at the start and end of a data transfer.

FIG. 27 is a block diagram showing an example of the constitution of the child data transfer program 2600c.

The child data transfer program 2600c comprises a data transfer management module 2601c, a control information communication module 2602c, and a data transfer readout module 2603c. The data transfer management module 2601c controls a data transfer in accordance with an indication from the parent data transfer program 2600p received via the control information communication module 2602c. The data transfer readout module 2603c reads out the data of a migration-targeted file in accordance with an indication from the data transfer management module 2601c.

Next, data migration processing in the second embodiment will be explained in detail.

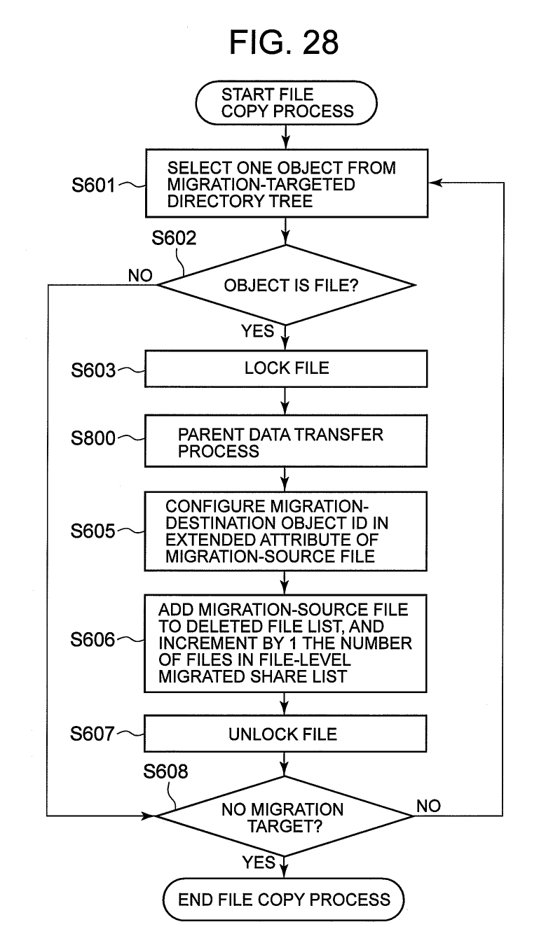

FIG. 28 is a flowchart of file copy processing carried out by the data migration program 4203 executed by the root node 200 in the second embodiment.

This process differs from that of the first embodiment in that data is transferred using network 2301 when carrying out a file copy. That is, instead of the processing of S604 in FIG. 21, the parent data transfer program 2600p carries out a parent data transfer process (S800).

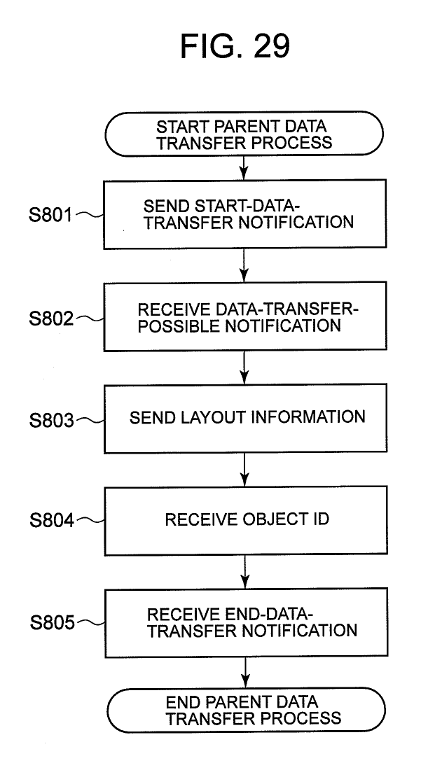

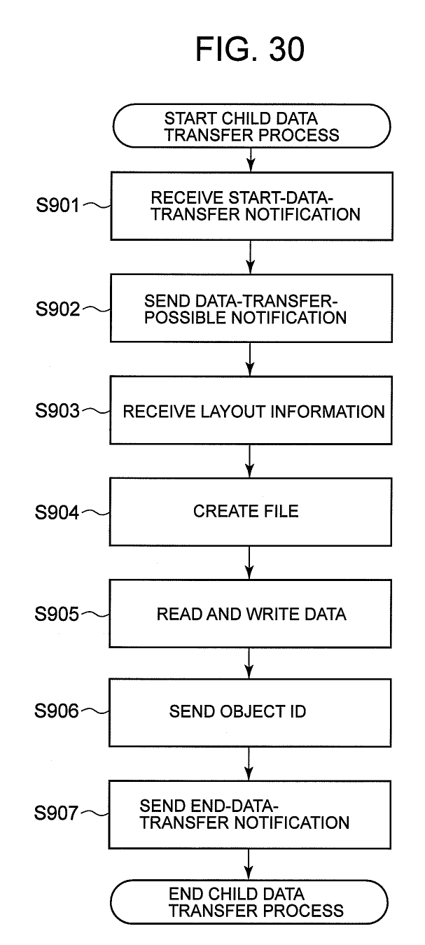

FIG. 29 is a flowchart of parent data transfer processing carried out by the parent data transfer program 2600p. Also, FIG. 30 is a flowchart of child data transfer processing carried out by the child data transfer program 2600c. Since the parent data transfer program 2600p and the child data transfer program 2600c carry out processing by communicating with one another, this processing will be explained below by referring to both FIG. 29 and FIG. 30 as needed.

First, the data transfer management module 2601p of the parent data transfer program 2600p sends a start-data-transfer communication from the control information communication module 2602p (S801). The destination is either the root node 200 or leaf node 300 comprising the child data transfer program 2600c.

The child data transfer program 2600c, upon receiving the start-data-transfer communication via the control information communication module 2602c (S901), notifies the parent data transfer program 2600p via the control information communication module 2602c that data transfer is possible (S902).

The parent data transfer program 2600p, upon receiving the data-transfer-possible communication (S802), acquires the layout information of the migration-targeted file (for example, i-node information in which a block number and so forth are recorded) from the file system program 203, and sends this layout information to the child data transfer program 2600c from the control information communication module 2602p (S803).

Upon receiving the layout information (S903), the child data transfer program 2600c creates a file (S904). The file created here is a free migration-destination file in which data 1503 does not exist. Then, based on this layout information, the data readout module 2603c reads out the data 1503 (data 1503 inside the migration-source file) from the file system 207 of the migration-source root node 200 via the network 2301, and writes this data 1503 to the file created in S904 (S905). When data read and write end, the child data transfer program 2600c sends the object ID (migration-destination object ID) of the created file, and an end-data-transfer notification to the parent data transfer program 2600p by way of the control information communication module 2602c (S906, S907).

The parent data transfer program 2600p receives the migration-destination object ID and end-data-transfer notification, and ends the data transfer process (S804, S805).

Furthermore, in this embodiment, the method is such that the parent data transfer program 2600p sends the layout information, and the data readout module 2603c of the child data transfer program 2600c reads the data, but data transfer can also be realized by the child data transfer program 2600c sending the layout information, and the parent data transfer program 2600p, which comprises a data write module, writing the data based on the received layout information.

According to this embodiment, since a dedicated network 2301 is used when copying data from the file system 207 of the migration-source root node 200 to the file system 207 of either a migration-destination root node 200 or leaf node 300, the burden on the network 101 of the client 100, root node 200 and leaf node 300 is less than in the first embodiment, and a highspeed copy process can be carried out.

The preceding is explanations of a number of embodiments of the present invention, but these embodiments are merely examples for explaining the present invention, and do not purport to limit the scope of the present invention solely to these embodiments. The present invention can be put into practice in a variety of other modes.

What is claimed is:

1. A root node, which carries out file-level virtualization for providing a plurality of share units that are logical export units and that comprise one or more objects, to a client as a single virtual namespace, and which is logically arranged between the client and a file server,
the root node comprising:
a migration processing module for migrating a file, which is an object, to either a leaf node, which is a file server for managing a share unit, or another root node, writing a migration-destination object ID, which corresponds to this file, and which comprises share information denoting a share unit, and updating migration determination information denoting a share unit, which either comprises or does not comprise a migrated file, to information denoting that a migrated file is included in the share unit comprising the file; and
a request transfer processing module for receiving, from either a client or another root node, request data having an object ID, and determining, by referencing the migration determination information, whether or not a share unit, which is denoted by the share information inside the object ID of this request data, is a migrated share unit comprising a migrated file, and when the result of this determination is positive and if the file corresponding to this object ID is a migrated file, specifying the written migration-destination object ID corresponding to this file, and transferring the request data having the specified migration-destination object ID to either the migration-destination leaf node or other root node.

2. The root node according to claim 1, wherein, when the result of the determination is negative, the request transfer processing module executes an operation in accordance with this request data without transferring the request data.

3. The root node according to claim 1, wherein the request transfer processing module references transfer control information in which share information is corresponded to node information denoting either the leaf node or the root node that manages the share unit denoted by this share information, and specifies the node information corresponding to the share information inside the object ID of the received request data, and if the specified node information denotes the root node, carries out the determination, and if the specified node information denotes either the leaf node or another root node, transfers the received request data to either this leaf node or the other root node.

4. The root node according to claim 1, wherein the write destination of the migration-destination object ID is a migration-source file.

5. The root node according to claim 4, wherein the file comprises attribute information related to the file, and real data, which is the data constituting the content of the file, and the write destination of the migration-destination object ID is the attribute information inside the migration-source file.

6. The root node according to claim 1, wherein the file comprises attribute information related to the file, and real data, which is the data constituting the content of the file, and the migration processing module migrates the real data inside this file to either the leaf node or the other root node without migrating the attribute information inside the file.

7. The root node according to claim 6, wherein the migration processing module deletes the real data, which has been migrated, from the migration-source file.

8. The root node according to claim 6, wherein, when the result of the determination is positive and if the received request data is data by which a response is possible without either referencing or updating the attribute information inside the migration-source file identified from the object ID of this request data, and without referencing or updating the real data, the request transfer processing module either references or updates the attribute information inside this migration-source file, and sends the response data corresponding to this request data either to the client, which is the source of this request data, or another root node without sending this request data to either the migration-destination leaf node or the other root node.

9. The root node according to claim 8, wherein, if the received request data is data for which the real data inside the migration-source file has to be either referenced or updated, and the attribute information inside this migration-source file has to be updated when processing this request data, the request transfer processing module changes the attribute information inside this migration-source file, and subsequently sends response data relative to this request data either to the client or the other root node, which is the source of this request data.

10. The root node according to claim 1, wherein the migration processing module acquires the file migrated from the share unit managed by the root node from either the migration-destination leaf node thereof, or the other root node, and if all the files migrated from this share unit have been acquired, updates the migration determination information to information denoting that this share unit does not comprise a migrated file.

11. The root node according to claim 10, wherein
the file comprises attribute information related to the file, and real data, which is the data constituting the content of the file,
the migration processing module migrates the real data in this file either to the leaf node or to the other root node without migrating the attribute information in the file, acquires the real data migrated from the share unit managed by the root node from either the migration-destination leaf node thereof or the other root node, and returns this real data to the migration-source file, and if all the real data migrated from this share unit has been acquired, and respectively returned to all the migration-source files, updates the migration determination information to information denoting that this share unit does not comprise a migrated file.

12. The root node according to claim 1, wherein the client, the root node, and either the leaf node or the other root node are connected to a first communication network, and
a storage unit, which stores an object included in a share unit, the root node, and either the leaf node or the other root node are connected to a second network, which is a different communication network from the first communication network.

13. The root node according to claim 12, wherein the migration processing module sends layout information denoting information related to the layout of a migration-source file either to the migration-destination leaf node or to the other root node by way of the first communication network, receives an object ID of a migration-destination file created based on this layout information from either the migration-destination leaf node or the other root node by way of the first communication network, and writes the received object ID as the migration-destination object ID.

14. A file server system, which provides a file service to a client, comprising a plurality of root nodes, which carries out file-level virtualization for providing a plurality of share units that are logical export units and that include one or more objects to a client as a single virtual namespace, the file server system being logically arranged between the client and a file server,
the respective root nodes comprising:
a migration processing module for migrating a file, which is an object, to either a leaf node or another root node, which is a file server for managing a share unit, writing a migration-destination object ID, which corresponds to this file, and which comprises share information denoting a share unit, and updating migration determination information, which denotes the share unit, which either comprises or does not comprise a migrated file, to information denoting that a migrated file is included in the share unit comprising the file; and
a request transfer processing module for receiving, from either a client or another root node, request data having an object ID, and determining, by referencing the migration determination information, whether or not the share unit, which is denoted by the share information inside the object ID of this request data, is a migrated share unit comprising a migrated file, and when the result of this determination is positive and if the file corresponding to this object ID is a migrated file, specifying the written migration-destination object ID corresponding to this file, and transferring the request data having the specified migration-destination object ID to either the migration-destination leaf node or other root node.

15. A data migration processing method realized by a computer system, which carries out file-level virtualization for providing a plurality of share units that are logical export units and that include one or more objects to a client as a single virtual namespace,
wherein a first file virtualization unit migrates a file, which is an object, either to a leaf node, which is a file server, or to a second file virtualization unit;
the first file virtualization unit writes a migration-destination object ID, which corresponds to the file, and which comprises share information denoting a share unit;
the first file virtualization unit updates migration determination information denoting a share unit, which either comprises or does not comprise a migrated file, to information denoting that the share unit comprising the file comprises a migrated file;
the first file virtualization unit receives request data having an object ID;
the first file virtualization unit determines, by referencing the migration determination information, whether or not the share unit, which is denoted by share information inside the object ID of this request data, is a migrated share unit comprising a migrated file; and
when the result of the determination is positive and if the file corresponding to this object ID is a migrated file, the first file virtualization unit specifies the written migration-destination object ID corresponding to this file, and transfers the request data having the specified migration-destination object ID to either the leaf node or the second file virtualization unit.
